(19) United States
(12) Patent Application Publication
(10) Pub. No.: US 2026/0304093 A1
(43) Pub. Date: Oct. 1, 2026

(54) INFORMATION PROCESSING APPARATUS, CONTROL METHOD, AND STORAGE MEDIUM

(71) Applicant: CANON KABUSHIKI KAISHA, Tokyo (JP)

(72) Inventor: RYOYA KAWAI, Kanagawa (JP)

(21) Appl. No.: 19/569,938

(22) Filed: Mar. 17, 2026

(30) Foreign Application Priority Data
Mar. 31, 2025 (JP) 2025-059906

(51) Int. Cl. H04W 8/00; H04W 48/20

(52) U.S. Cl. CPC H04W 8/005; H04W 48/20

(57) ABSTRACT

A non-transitory computer-readable storage medium stores a program for communicating with a communication apparatus, the program causing a computer of an information processing apparatus equipped with an operating system (OS) including an AccessorySetupKit (ASK) module to perform a method including: receiving, from a user, an input concerning a model of the communication apparatus targeted for searching, notifying the ASK module of image data representing a model corresponding to the received input and a character string corresponding to the model corresponding to the received input, and transmitting connection information for connecting to an access point to the communication apparatus found by searching performed by the ASK module in response to being notified of the image data and the character string, wherein, in a case where the communication apparatus having identification information including the character string has been found, an image represented by the image data is displayed.

### BACKGROUND

### Field of the Technology

The aspect of the embodiments relates to an information processing apparatus, a control method, and a storage medium.

### Description of the Related Art

Some configurations in which, in response to an information processing apparatus such as a smartphone transmitting information for connecting to an access point to a communication apparatus such as a printer, the communication apparatus connects to the access point with use of the transmitted information are known. Japanese Patent Laid-Open No. 2016-127545 describes a method of, in response to an information processing apparatus transmitting information to a communication apparatus, setting, to the communication apparatus, a connection mode for determining a connection configuration between the information processing apparatus and the communication apparatus.

Furthermore, as configurations for transmitting information for connecting to an access point to a communication apparatus become widespread, it is desired to improve the usability of an application program for executing processing for transmitting information for connecting to an access point to a communication apparatus.

### SUMMARY

According to an aspect of the embodiments, a non-transitory computer-readable storage medium storing a program for communicating with a communication apparatus, the program causing a computer of an information processing apparatus equipped with an operating system (OS) including an AccessorySetupKit (ASK) module to perform a method comprising: receiving, from a user, an input concerning a model of the communication apparatus targeted for searching, notifying the ASK module of image data representing a model corresponding to the received input and a character string corresponding to the model corresponding to the received input, and transmitting connection information for connecting to an external access point to the communication apparatus found by searching performed by the ASK module in response to being notified of the image data and the character string, wherein, in a case where an apparatus having identification information including the character string is searched for by the ASK module and the communication apparatus having identification information including the character string has been found by the ASK module, an image represented by the image data is displayed by the ASK module.

Features of the disclosure will become apparent from the following description of embodiments with reference to the attached drawings. The following description of embodiments is described by way of example.

### BRIEF DESCRIPTION OF THE DRAWINGS

FIG. 1 is a diagram illustrating an example of a communication system.

FIG. 2 is an example of a configuration diagram of a terminal device and a communication apparatus.

FIG. 3 is a flowchart illustrating an example of first connection setting process.

FIG. 4 is a diagram illustrating an example of a screen for registering a communication apparatus with a predetermined application.

FIG. 5 is a diagram illustrating an example of a model name input screen.

FIG. 6 is a diagram illustrating an example of a screen for manually connecting to a communication apparatus which is operating a connection setting mode.

FIG. 7 is a diagram illustrating an example of a screen for displaying a list of access points (APs).

FIG. 8 is a diagram illustrating an example of a password input screen.

FIG. 9 is a flowchart illustrating an example of processing which the terminal device performs to determine a method of connection setting process with use of a predetermined application.

FIG. 10 is a flowchart illustrating an example of second connection setting process.

FIGS. 11A and 11B are diagrams each illustrating an example of a screen indicating a search result.

FIG. 12 is a diagram illustrating an example of a screen indicating that an accessory has become available.

FIG. 13 is a diagram illustrating an example of a screen for password confirmation.

FIG. 14 is a diagram illustrating an example of a notification screen for preventing the predetermined application from being caused to transition to background.

FIG. 15 is a flowchart illustrating an example of first connection setting process.

FIGS. 16A and 16B are flowcharts illustrating an example of second connection setting process.

FIG. 17 is a diagram illustrating an example of a model name input screen.

FIG. 18 is a diagram illustrating an example of a screen indicating a search result.

FIG. 19 is a diagram illustrating an example of a screen indicating a search result.

### DESCRIPTION OF THE EMBODIMENTS

### First Embodiment

An information processing apparatus and a communication apparatus which are included in a communication system according to a first embodiment are described. The information processing apparatus is also referred to as a “terminal device”. While, in the first embodiment, a smartphone is taken as an example of the information processing apparatus, the first embodiment is not limited to this. The information processing apparatus to be applicable includes various pieces of equipment, such as a personal computer (PC), a tablet terminal, a personal digital assistant (PDA), and a digital camera. In the first embodiment, a printer is taken as an example of the communication apparatus. The printer can be an inkjet printer, which performs printing with ink, or a laser beam printer, which performs printing with toner. Moreover, the printer can be a full-color printer, which is capable of performing color print, or a monochrome printer, which is incapable of performing color print but is capable of performing monochrome print. Furthermore, in the first embodiment, the communication apparatus is not limited to a printer, but can be any type of communication apparatus as long as it is an apparatus capable of performing wireless communication with the information processing apparatus. The communication apparatus to be applicable includes, for example, a copying machine, a facsimile apparatus, a scanner, a smartphone, a PC, a tablet terminal, a PDA, a digital camera, a music playback device, a television set, a smart loudspeaker, a robot vacuum cleaner, an automatic cooking pot, and a refrigerator. Besides, the communication apparatus to be applicable also includes a multifunction peripheral equipped with a plurality of functions such as a copying function, a facsimile (FAX) function, and a printing function.

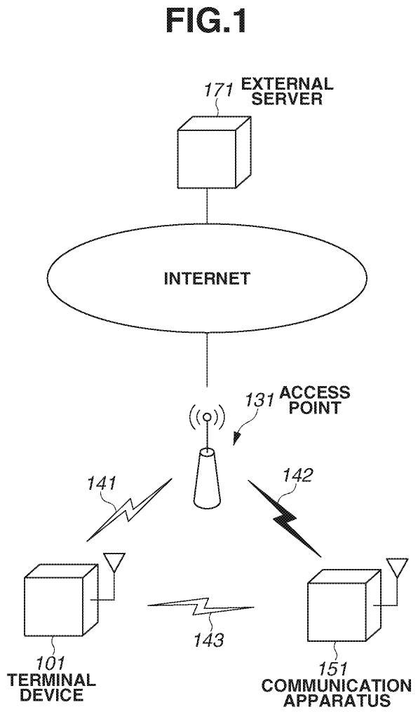

First, a system configuration for implementing the first embodiment is described. FIG. 1 is a diagram illustrating an example of a configuration of a communication system according to the first embodiment. The communication system is assumed to include a communication apparatus 151, a terminal device 101, an access point (AP) 131, and an external server 171.

The terminal device 101 is an information processing apparatus in the first embodiment. The communication apparatus 151 is a communication apparatus in the first embodiment. The AP 131 is an access point which is activated by an external device which exists outside the terminal device 101 and outside the communication apparatus 151. The external device is, for example, a wireless local area network (LAN) router. The external server 171 is a server which is capable of providing, via the Internet, a service to a device or apparatus which is connecting to the AP 131.

In a situation in which the communication apparatus 151 and the terminal device 101 are connecting to the AP 131, the AP 131, the communication apparatus 151, and the terminal device 101 are included in a LAN formed by the AP 131. On the other hand, the AP 131 and the external server 171 are included in a wide area network (WAN).

In the first embodiment, in a case where an infrastructure connection described below is currently established, the terminal device 101 is able to communicate with the communication apparatus 151 via the AP 131. Additionally, in a case where a direct connection described below is currently established, the terminal device 101 is able to directly communicate with the communication apparatus 151 without via the AP 131. Furthermore, in the following description, the connection to an AP is equivalent to the connection to a network which the AP forms. Furthermore, one external device can be configured to be activating a plurality of APs and one external device can be configured to be able to concurrently form a plurality of networks.

In the first embodiment, each of a connection 141 between the terminal device 101 and the AP 131 and a connection 142 between the communication apparatus 151 and the AP 131 is assumed to be a connection using a communication method that is based on the standard of IEEE 802.11 series. The communication method that is based on the standard of IEEE 802.11 series is, specifically, Wi-Fi® (Wireless Fidelity). Moreover, a connection 143 between the terminal device 101 and the communication apparatus 151 is also assumed to be a connection using a communication method that is based on the standard of IEEE 802.11 series. However, the communication method to be used for the connection 143 is not limited to this configuration, and can be, for example, Bluetooth® Low Energy (BLE), Bluetooth Classic, Wi-Fi Aware, or Near Field Communication (NFC). The AP 131 and the external server 171 are able to communicate with each other via the Internet, and, in a state in which the AP 131 is currently connecting to the Internet, a device or apparatus (the terminal device 101 or the communication apparatus 151) which is currently connecting to the AP 131 is also able to use the Internet. Furthermore, each of the connection 141 between the terminal device 101 and the AP 131 and the connection 142 between the communication apparatus 151 and the AP 131 can be a connection using a wired LAN.

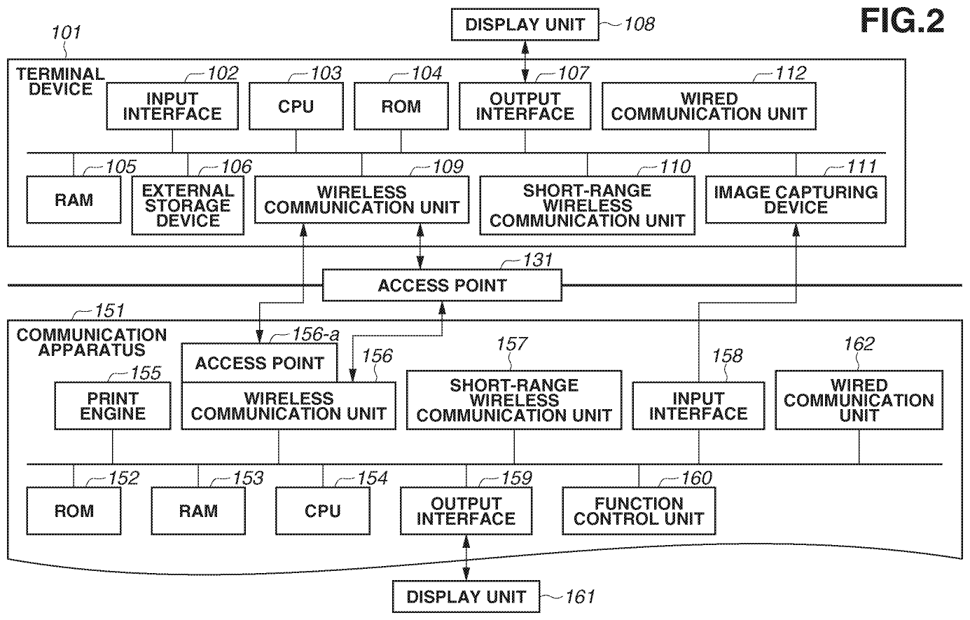

Next, configurations of an information processing apparatus in the first embodiment and a communication apparatus which is able to communicate with the information processing apparatus in the first embodiment are described with reference to the block diagram of FIG. 2. Moreover, while, in the first embodiment, the following configurations are described as an example, the first embodiment is applicable to an apparatus capable of communicating with a communication apparatus and is not specifically limited in function to the configurations illustrated in FIG. 2.

The terminal device 101 includes, for example, an input interface 102, a central processing unit (CPU) 103, a read-only memory (ROM) 104, a random access memory (RAM) 105, an external storage device 106, an output interface 107, a display unit 108, a wireless communication unit 109, a short-range wireless communication unit 110, an image capturing device 111, and a wired communication unit 112. A computer of the terminal device 101 is formed by, for example, the CPU 103, the ROM 104, and the RAM 105.

The input interface 102 is an interface for receiving a data input or an operation instruction from the user, and is configured with, for example, a physical keyboard, buttons, and a touch panel. Furthermore, the output interface 107 described below and the input interface 102 can be integrated into the same configuration, so that outputting of a screen and receiving of an operation from the user can be performed with the same configuration.

The CPU 103, which is a system control unit, controls the entire terminal device 101. In the first embodiment, the CPU 103 performs, for example, control of a display content in the display unit 108 (display control).

The ROM 104 stores fixed data, such as control programs which the CPU 103 executes, data tables, and an operating system (OS) program. In the first embodiment, the control programs stored in the ROM 104 are executed to perform software execution control, such as scheduling, task switches, and interrupt processing, under the control of the embedded OS stored in the ROM 104. In the first embodiment, the ROM 104 stores a predetermined application program (application) for controlling the communication apparatus 151. The application program is, in other words, application software. The predetermined application program is installed from an external unit onto the terminal device 101 by, for example, a store application for installing various applications. Moreover, the predetermined application program is an application which the vendor of the communication apparatus 151 provides. In the first embodiment, the predetermined application program is an application for communicating with the communication apparatus 151 and performing a connection setting of the communication apparatus 151. In the following description, the predetermined application program is referred to as a “predetermined application”. Furthermore, the predetermined application can include a function other than the function for performing a connection setting of the communication apparatus 151. The other function is, specifically, for example, a function which transmits a print job for causing the communication apparatus 151 to perform printing (a print job transmission function) or a function which transmits a scan job for causing the communication apparatus 151 to perform scanning (a scan job transmission function). Furthermore, in the first embodiment, processing which is described as processing which the OS executes is, to be precise, processing which the CPU 103 executes according to a program included in the OS. Similarly, processing which is described as processing which an application executes is, to be precise, processing which the CPU 103 executes according to a program included in the application.

The RAM 105 is configured with, in one embodiment, for example, a static random access memory (SRAM), which requires a backup power source. Furthermore, the RAM 105 retains data with a primary battery for data backup (not illustrated) and is, therefore, able to store important data such as program control variables without volatizing the data. Moreover, a memory area for storing, for example, setting information about the terminal device 101 or management data about the terminal device 101 is also provided in the RAM 105. Moreover, the RAM 105 is also usable as a main memory and work memory for the CPU 103.

The external storage device 106 stores, for example, various programs such as a print information generation program for generating print information which the communication apparatus 151 is able to interpret and an information transmission and reception control program for performing transmission and reception with the communication apparatus 151 connected via the wireless communication unit 109. Moreover, the external storage device 106 also stores various pieces of information which the various programs use or image data obtained from another information processing apparatus or the Internet.

The output interface 107 is an interface which performs control for the display unit 108 to perform displaying of data or notification of the state of the terminal device 101.

The display unit 108 is configured with, for example, a light-emitting diode (LED) or a liquid crystal display (LCD), and performs displaying of data or notification of the state of the terminal device 101. Furthermore, a software keyboard equipped with keys such as numerical value input keys, mode setting keys, a determination key, a cancel key, and a power key can be mounted on the display unit 108, so that the terminal device 101 can receive an input from the user via the display unit 108. In the first embodiment, the display unit 108 is assumed to be a touch panel and be capable of receiving an operation performed with an operator such as a finger or pen by the user.

The wireless communication unit 109 is a configuration which connects to an apparatus such as the communication apparatus 151 or the AP 131 by wireless to perform data communication therewith. For example, the wireless communication unit 109 can directly communicate with the communication apparatus 151 by wireless communication or can communicate with the communication apparatus 151 via the AP 131, which exists outside the terminal device 101 or the communication apparatus 151. In the first embodiment, as a wireless communication method for the wireless communication unit 109, Wi-Fi, which is a communication method that is based on the IEEE 802.11 standard, is assumed to be used, but, for example, Bluetooth Classic can be used. Moreover, in the first embodiment, the wireless LAN is assumed to be a network using Wi-Fi. Furthermore, in the first embodiment, a connection using a method in which the terminal device 101 and the communication apparatus 151 directly connect to each other without via an external AP is referred to as a “direct connection”. Moreover, a connection using a method in which the terminal device 101 and the communication apparatus 151 connect to each other via an external AP is referred to as an “infrastructure connection (infra connection)”.

The short-range wireless communication unit 110 is a configuration which performs data communication using a short-range wireless communication method with an apparatus such as the communication apparatus 151, and performs communication using a communication method different from that for the wireless communication unit 109. The short-range wireless communication unit 110 is able to connect to a short-range wireless communication unit 157 included in the communication apparatus 151. Furthermore, examples of the communication method for the short-range wireless communication unit 110 include BLE, Bluetooth Classic, Wi-Fi Aware, and Near Field Communication (NFC).

The image capturing device 111 is a device which converts an image captured by an image sensor into digital data.

The digital data is once stored in the RAM 105. After that, the digital data is converted into a predetermined image format by a program which the CPU 103 executes and is then stored as image data in the external storage device 106.

The wired communication unit 112 is a configuration which connects to an apparatus such as the communication apparatus 151 or the AP 131 by wire to perform data communication. For example, the wired communication unit 112 performs communication using a wired LAN. In the first embodiment, the wired LAN is assumed to be used for a communication using the Ethernet standard. Furthermore, the first embodiment is not limited to this configuration, and the wired communication unit 112 can perform communication using, for example, a Universal Serial Bus (USB) cable. Moreover, for example, in a case where the terminal device 101 is a smartphone, the terminal device 101 does not need to include the wired communication unit 112.

The communication apparatus 151 includes, for example, a ROM 152, a RAM 153, a CPU 154, a print engine 155, a wireless communication unit 156, a short-range wireless communication unit 157, an input interface 158, an output interface 159, a function control unit 160, a display unit 161, and a wired communication unit 162.

A computer of the communication apparatus 151 is formed by, for example, the ROM 152, the RAM 153, and the CPU 154.

The wireless communication unit 156 is a configuration which connects to an apparatus such as the terminal device 101 or the AP 131 by wireless to perform data communication therewith. In the first embodiment, as a wireless communication method for the wireless communication unit 156, Wi-Fi, which is a communication method that is based on the IEEE 802.11 standard, is assumed to be used, but, for example, Bluetooth Classic can be used. Furthermore, the wireless communication unit 156 includes, as an AP inside the communication apparatus 151, an AP 156-a, which is used to connect to an apparatus such as the terminal device 101. Furthermore, the AP 156-a is able to connect to the wireless communication unit 109 of the terminal device 101. Furthermore, the wireless communication unit 156 can directly communicate with the terminal device 101 via the AP 156-a or can communicate with the terminal device 101 via the AP 131. Moreover, the AP 156-a can be hardware which functions as an AP, or the wireless communication unit 156 can operate as the AP 156-a by software for causing the wireless communication unit 156 to function as an AP. Moreover, the communication apparatus 151 can include a plurality of APs different in service set identifier (SSID) or password and internally activate the plurality of APs.

The RAM 153 is configured with, in one embodiment, for example, a dynamic random access memory (DRAM), which requires a backup power source. Furthermore, the RAM 153 retains data with electric power for data backup (not illustrated) supplied thereto and is, therefore, able to store important data such as program control variables without volatizing the data. Moreover, the RAM 153 is also usable as a main memory and work memory for the CPU 154, and includes a receive buffer for temporarily storing print information received from, for example, the terminal device 101 and for storing various pieces of information.

The ROM 152 stores fixed data, such as control programs which the CPU 154 executes, data tables, and an operating system (OS) program. In the first embodiment, the control programs stored in the ROM 152 are executed to perform software execution control, such as scheduling, task switches, and interrupt processing, under the control of the embedded OS stored in the ROM 152. Moreover, in one embodiment, a memory area for storing data which is required to be retained even at the time of electric power not being supplied, such as setting information about the communication apparatus 151 or management data about the communication apparatus 151, is also provided in the ROM 152.

The CPU 154, which is a system control unit, controls the entire communication apparatus 151.

The print engine 155 performs image formation on a recording medium, such as paper, using a recording agent, such as ink, based on information stored in the RAM 153 or a print job received from, for example, the terminal device 101, and then outputs a printed result. At this time, a print job which is transmitted from, in one embodiment, for example, the terminal device 101, is large in the amount of transmitted data and requires high-speed communication and is, therefore, assumed to be received via the wireless communication unit 156, which is able to perform communication at higher speed than the short-range wireless communication unit 157.

The short-range wireless communication unit 157 is a configuration which performs data communication using a short-range wireless communication method with an apparatus such as the terminal device 101. Furthermore, examples of the communication method for the short-range wireless communication unit 157 include BLE, Bluetooth Classic, and Wi-Fi Aware.

The input interface 158 is an interface for receiving a data input or an operation instruction from the user, and is configured with, for example, a physical keyboard, buttons, and a touch panel. Furthermore, the output interface 159 described below and the input interface 158 can be integrated into the same configuration, so that outputting of a screen and receiving of an operation from the user can be performed with the same configuration. The output interface 159 is an interface which performs control for the display unit 161 to perform displaying of data or notification of the state of the communication apparatus 151.

The function control unit 160 performs management of a functional operation as to whether to cause functions included in the communication apparatus 151 to concurrently operate.

The display unit 161 is configured with, for example, a light-emitting diode (LED) or a liquid crystal display (LCD), and performs displaying of data or notification of the state of the communication apparatus 151. Furthermore, a software keyboard equipped with keys such as numerical value input keys, mode setting keys, a determination key, a cancel key, and a power key can be mounted on the display unit 161, so that the communication apparatus 151 can receive an input from the user via the display unit 161.

The wired communication unit 162 is a configuration which connects to an apparatus such as the terminal device 101 or the AP 131 by wire to perform data communication. For example, the wired communication unit 162 performs communication using a wired LAN. Furthermore, the first embodiment is not limited to this configuration, and the wired communication unit 162 can perform communication using, for example, a USB cable.

### Direct Connection Method

The direct connection refers to a configuration in which apparatuses directly (i.e., peer-to-peer) perform wireless connection with each other without via an external apparatus such as the AP 131. The direct connection is also referred to as “peer-to-peer connection (P2P connection)”. The communication apparatus 151 is capable of operating in a mode for performing communication using direct connection (in a direct connection mode) as one of connection modes. In Wi-Fi communication, as modes for performing communication using direct connection, there is a plurality of modes such as a software AP mode and a Wi-Fi Direct (WFD) mode.

The mode for performing the direct connection by WFD is referred to as a “WFD mode”. WFD is a standard formulated by the Wi-Fi Alliance, and is a standard included in the communication standard of the IEEE 802.11 series. In the WFD mode, after equipment serving as a communication partner has been searched for by the use of an equipment search command, the roles of a group owner (GO) for P2P and a client for P2P are determined and then, the remaining processing for wireless connection is performed. The group owner is equivalent to a mater station (master equipment) for Wi-Fi, and the client is equivalent to a slave station (slave equipment) for Wi-Fi. Such role determination corresponds to, for example, GO Negotiation in P2P. Furthermore, in a WFD mode in a state obtained before the role determination is performed, the communication apparatus 151 is in a state of being neither a master station nor a slave station. Specifically, first, among pieces of equipment which perform communication, one equipment issues an equipment search command and thus searches for equipment to which to perform connection in the WFD mode. If the other equipment serving as a communication partner has been found, both pieces of equipment check information concerning a service or function which both pieces of equipment are able to mutually supply. Furthermore, such equipment supply information check is optional and non-essential. This equipment supply information check phase corresponds to, for example, Provision Discovery in P2P. Next, by mutually checking such equipment supply information, both pieces of equipment determine, as the respective roles of equipment, which equipment becomes a client for P2P and which equipment becomes a group owner for P2P. Next, if the client and the group owner have been determined, both pieces of equipment exchange parameters for performing communication using WFD therebetween. Based on the exchanged parameters, the client and group owner for P2P perform the remaining processing of wireless connection and processing of Internet Protocol (IP) connection. Furthermore, in the WFD mode, the communication apparatus 151 can be configured to, without performing the above-mentioned GO Negotiation, necessarily operate as a GO. Thus, the communication apparatus 151 can operate with a WFD mode which is an autonomous GO mode. Moreover, the state in which the communication apparatus 151 is operating with the WFD mode is, for example, a state in which, although a connection using WFD is not yet established, the communication apparatus 151 is operating as a GO or a state in which a connection using WFD is currently established and the communication apparatus 151 is operating as a GO.

In the software AP mode, among pieces of equipment (for example, the terminal device 101 and the communication apparatus 151) which perform communication, one equipment (for example, the terminal device 101) becomes a client which fulfills a role of requesting various services. Then, the other equipment implements the function of an AP in Wi-Fi by settings of software. A software AP is equivalent to a master station in Wi-Fi, and a client is equivalent to a slave station in Wi-Fi. In the software AP mode, the client searches for equipment serving as a software AP by the use of an equipment search command. If a software AP has been found, the client and the software AP perform the remaining processing of wireless connection (for example, establishment of wireless connection) and then perform processing of IP connection (for example, allocation of an IP address). Furthermore, in one embodiment, with regard to commands or parameters which are transmitted and received in the case of implementing wireless connection between the client and the software AP, commands or parameters defined by the Wi-Fi standard only need to be used, and the description thereof is omitted here.

In the first embodiment, in a case where the communication apparatus 151 is establishing and maintaining direct connection, the communication apparatus 151 operates as a master station within a network to which the communication apparatus 151 belongs. Furthermore, the master station is a device which constructs a wireless network and is a device which provides, to a slave station, parameters which are used for connection to a wireless network. The parameters which are used for connection to a wireless network are, for example, parameters concerning a channel which the master station is using. In response to receiving the parameters, the slave station connects to a wireless network which the master station is constructing with use of the channel which the master station is using. In the direct connection mode, since the communication apparatus 151 operates as a master station, the communication apparatus 151 is able to determine which frequency band to use and which channel to use in a communication in the direct connection mode. In the first embodiment, for a communication in the direct connection mode, the communication apparatus 151 is assumed to be able to use a channel corresponding to a frequency band of 2.4 gigahertz (GHz) and a channel corresponding to a frequency band of 5 GHz.

### Infrastructure Connection Method

The infrastructure connection is a connection configuration in which pieces of equipment which perform communication (for example, the terminal device 101 and the communication apparatus 151) connect to an AP which coordinates a network (for example, the AP 131) and both pieces of equipment perform communication with each other via an AP. The communication apparatus 151 is also able to operate with a mode for performing communication using infrastructure connection (infrastructure connection mode) as one of connection modes.

In the infrastructure connection, each piece of equipment searches for an AP by the use of an equipment search command. If an AP has been found, each piece of equipment and the AP perform the remaining processing of wireless connection (for example, establishment of wireless connection) and then perform processing of IP connection (for example, allocation of an IP address). Furthermore, in one embodiment, with regard to commands or parameters which are transmitted and received in the case of implementing wireless connection between each piece of equipment and the AP, commands or parameters defined by the Wi-Fi standard only need to be used, and the description thereof is omitted here.

In the first embodiment, when the communication apparatus 151 operates with the infrastructure connection, the AP 131 operates as a master station and the communication apparatus 151 operates as a slave station. Thus, in the first embodiment, the infrastructure connection refers to a connection between the communication apparatus 151, which operates as a save station, and an apparatus which operates as a master station. In a case where the communication apparatus 151 has established infrastructure connection and the terminal device 101 also has established infrastructure connection with the AP 131, the communication apparatus 151 and the terminal device 101 become able to perform communication with each other via the AP 131. Since a channel which is used for a communication in the infrastructure connection is determined by the AP 131, the communication apparatus 151 performs communication in the infrastructure connection with use of a channel determined by the AP 131. In the first embodiment, for a communication in the infrastructure connection, the communication apparatus 151 is assumed to be able to use a channel corresponding to a frequency band of 2.4 GHz and a channel corresponding to a frequency band of 5 GHz. Furthermore, for a communication in the infrastructure connection, the communication apparatus 151 is also able to use a channel corresponding to a dynamic frequency selection (DFS) band included in a frequency band of 5 GHz. Furthermore, to perform communication with the communication apparatus 151 via the AP 131, the terminal device 101 recognizes and identifies that the communication apparatus 151 belongs to a network which is formed by the AP 131 and to which the terminal device 101 belongs.

### Connection Setting Process

In the first embodiment, the terminal device 101 performs, with use of wireless communication with the communication apparatus 151, a connection setting (network setting) which is a setting for causing the communication apparatus 151 to operate with at least one communication method selected from the infrastructure connection and the direct connection. Connection setting process in the first embodiment is performed with wireless communication and is, therefore, also referred to as a “cableless setup (CLS)”. Furthermore, the connection setting process can also be performed with wired communication. When a predetermined application stored in, for example, the external storage device 106 has been activated, the terminal device 101 performs connection setting process with respect to the communication apparatus 151. The communication apparatus 151 is able to operate with a connection setting mode (connection setting state) which is a mode for performing connection setting process, and performs the connection setting process in a state of being operating in the connection setting mode described below. The details of the connection setting mode are described below.

When causing the communication apparatus 151 to operate with the infrastructure connection mode, the terminal device 101 wirelessly transmits, to the communication apparatus 151, infrastructure setting information, which is setting information for causing the communication apparatus 151 to operate with the infrastructure connection mode. The infrastructure setting information includes information concerning the AP 131. The information concerning the AP 131 is, for example, information about a service set identifier (SSID), a password, or a frequency band.

On the other hand, when causing the communication apparatus 151 to operate with the direct connection mode, the terminal device 101 wirelessly transmits, to the communication apparatus 151, direct setting information, which is setting information for causing the communication apparatus 151 to operate with the direct connection mode. The direct setting information includes an instruction for enabling the WFD function and causing the communication apparatus 151 to operate as a group owner or enabling an access point setting of the communication apparatus 151. Moreover, in one embodiment, the terminal device 101 acquires, from the communication apparatus 151, connection information required for performing direct connection to the communication apparatus 151. The connection information required for performing direct connection to the communication apparatus 151 includes, for example, information about an SSID or password of the communication apparatus 151, which operates with the direct connection mode.

In the first embodiment, direct connection for connection setting between the terminal device 101 and the communication apparatus 151 is used for the transmission of infrastructure setting information or direct setting information or the acquisition of information for performing direct connection to the communication apparatus 151 in the connection setting process. Then, while, in the first embodiment, as direct connection for connection setting, connection setting process using Wi-Fi is performed, for example, a wireless communication standard other than Wi-Fi, such as Bluetooth, can be used. Moreover, as direct connection for connection setting, a wired communication standard such as a wired LAN or Universal Serial Bus (USB) can also be used.

After infrastructure connection or direct connection using Wi-Fi has been established between the terminal device 101 and the communication apparatus 151 by the connection setting process, a communication becomes enabled between the terminal device 101 and the communication apparatus 151 via the established connection. Specifically, for example, the terminal device 101 is able to transmit, to the communication apparatus 151 via the established connection, a print job for causing the communication apparatus 151 to perform printing or a scan job for causing the communication apparatus 151 to perform scanning. Furthermore, while, in the first embodiment, the connection setting process enables both the communication apparatus 151 to operate with the infrastructure connection mode and the communication apparatus 151 to operate with the direct connection mode, the first embodiment is not limited to this configuration. For example, in one embodiment, a configuration in which the connection setting process enables only the communication apparatus 151 to operate with the infrastructure connection mode (thus, does not enable the communication apparatus 151 to operate with the direct connection mode) can be employed.

Furthermore, in the connection setting process, which the predetermined application performs, for example, Simple Network Management Protocol (SNMP) is used for a communication between the terminal device 101 and the communication apparatus 151.

### Connection Setting Mode

The communication apparatus 151 is able to operate with the connection setting mode. A trigger for the communication apparatus 151 starting an operation with the connection setting mode can be, for example, a connection setting mode button being pressed by the user or the communication apparatus 151 being started up (powered on) for the first time after shipment. The connection setting mode button can be a hardware button included in the communication apparatus 151 or can be a software button which the communication apparatus 151 displays on the display unit 161.

When starting an operation with the connection setting mode, the communication apparatus 151 enables Wi-Fi communication. Specifically, as processing for enabling Wi-Fi communication, the communication apparatus 151 enables an AP inside the communication apparatus 151 exclusively used for the connection setting mode (a connection setting AP). With this processing, the communication apparatus 151 becomes able to establish a direct connection using Wi-Fi with the terminal device 101. At least a part of connection information (SSID or password) for connecting to the connection setting AP is preliminarily retained in the predetermined application installed on the terminal device 101. Thus, the terminal device 101 is assumed to preliminarily recognize at least a part of connection information for connecting to the connection setting AP. Therefore, unlike connection information for an AP which is enabled in the direct connection mode, at least a part of connection information for connecting to the connection setting AP is assumed to be unable to be optionally changed by the user. Here, the details of an SSID of the connection setting AP and the details of information preliminarily retained in the predetermined application included in the SSID in the first embodiment are described.

In the first embodiment, the SSID of the connection setting AP is assumed to include a character string which is in common between apparatuses of one and the same model, a character string which is in common between apparatuses of a plurality of models, and an individual character string. The character string which is in common between apparatuses of one and the same model is equivalent to a character string which is in common between apparatuses of a predetermined model which a predetermined vendor provides but is not in common between an apparatus of the predetermined model which the predetermined vendor provides and an apparatus of another model which the predetermined vendor provides. In the following description, the character string which is in common between apparatuses of one and the same model is referred to as a “model-by-model common character string”. The model-by-model common character string is, specifically, a character string including a character string representing a model name. Furthermore, in one embodiment, the character string representing a model name is not limited to a character string composed only of a model name, but only needs to be a character string in which a model name is included. Moreover, the first embodiment is not limited to this configuration, and, for example, the character string representing a model name can be not a character string including a character string representing a model name but a character string allocated for each model name. Moreover, the character string which is in common between apparatuses of a plurality of models is a character string which is in common between an apparatus of a predetermined model which a predetermined vendor provides and an apparatus of another model which the predetermined vendor provides. The character string which is in common between apparatuses of a plurality of models is assumed to be, specifically, a character string including a character string “SETUP” and a character string which does not include a vendor name. Furthermore, the first embodiment is not limited to this configuration, and the character string which is in common between apparatuses of a plurality of models can be a character string including a vendor name. Moreover, the individual character string is equivalent to a character string which differs for each communication apparatus. Specifically, the individual character string is assumed to be a random character string which varies each time the connection setting mode is activated or a character string including a serial number of the apparatus. However, the first embodiment is not limited to this configuration, and the individual character string can be a fixed character string. Moreover, while, in the first embodiment, the sequential order of a character string included in an SSID of the connection setting AP is assumed to be an order of a character string which is in common between apparatuses of a plurality of models, a model-by-model common character string, and an individual character string in this sequence, the first embodiment is not limited to this configuration, and any sequential order can be employed. Furthermore, in one embodiment, a model-by-model common character string only needs to be included in an SSID of the connection setting AP. Therefore, as long as a model-by-model common character string is included in an SSID of the connection setting AP, both or any one of a character string which is in common between apparatuses of a plurality of models and an individual character string does not need to be included therein.

Moreover, the information preliminarily retained in the predetermined application included in an SSID of the connection setting AP in the first embodiment is a plurality of character strings allocated for each model name of the communication apparatus. The character string allocated for each model name is, in other words, a character string of at least a part of a character string constituting an SSID of the connection setting AP and is a model-by-model common character string. Furthermore, in the disclosure, the predetermined application does not need to preliminarily retain a plurality of character strings allocated for each model name.

Furthermore, a configuration in which an encryption method is not set for the connection setting AP and no password is required for connection to the connection setting AP can be employed. Furthermore, in the connection setting mode, the communication apparatus 151 can connect to the terminal device 101 not via ordinary Wi-Fi but via Wi-Fi Direct (WFD). Thus, the communication apparatus 151 can operate as a group owner and receive a setting command from the terminal device 101 by a communication using WFD. Furthermore, in the connection setting mode, the communication apparatus 151 can enable a communication other than Wi-Fi communication, such as BLE communication. Thus, the communication apparatus 151 can perform the connection setting process by a communication method other than Wi-Fi.

### Registration of Communication Apparatus with Application

In the first embodiment, the predetermined application is able to register the communication apparatus 151 with the predetermined application by acquiring, from the communication apparatus 151, information concerning the communication apparatus 151.

The information concerning the communication apparatus 151 is, for example, capability information about the communication apparatus 151, identification information (for example, media access control (MAC) address) about the communication apparatus 151, or model information about the communication apparatus 151. The capability information about the communication apparatus 151 includes, specifically, for example, a list of pieces of information about functions with which the communication apparatus 151 is compatible, information about consumables (ink and paper) which are usable in the communication apparatus 151, and information indicating a printing method used in the communication apparatus 151. Then, the predetermined application selects, from among one or a plurality of communication apparatuses 151 registered with the predetermined application, one apparatus which serves as a partner for communication performed by the predetermined application. In the following description, a communication apparatus 151 which is currently selected as an apparatus which serves as a partner for communication performed by the predetermined application is referred to as a “currently selected communication apparatus 151”. Furthermore, selecting an apparatus which serves as a partner for communication performed by the predetermined application can be performed by receiving, from the user, a selection from among one or a plurality of communication apparatuses 151 registered with the predetermined application or can be automatically performed according to a predetermined criterion by the predetermined application. Moreover, changing an apparatus which serves as a partner for communication performed by the predetermined application can be performed by, for example, receiving, from the user, a selection from among one or a plurality of communication apparatuses 151 registered with the predetermined application. In the first embodiment, the predetermined application transmits various jobs such as a print job and a scan job to the currently selected communication apparatus 151. Thus, the currently selected communication apparatus 151 is an apparatus serving as a transmission destination of various jobs.

### Issue to be Solved by First Embodiment

As mentioned above, in the first embodiment, to perform connection setting process, it is necessary to establish a connection between the communication apparatus 151 and the terminal device 101. Then, there is a configuration in which, to establish such a connection, the predetermined application invokes a first application programming interface (API). The first API is an API for issuing both instructions for searching for a communication apparatus and connecting to the found communication apparatus at once. Moreover, the first API is an API which is invoked to perform searching for a communication apparatus and connect to the found communication apparatus, without using a function included in a module called “AccessorySetupKit” described below. Furthermore, the first API is an API which is invoked based on program code “apply(_:completionHandler:)”. In the case of a configuration in which the predetermined application invokes the first API to cause a network setting module included in the OS to perform searching, in a screen representing a search result, identification information corresponding to a targeted communication apparatus found by searching is displayed as text only. Furthermore, the network setting module is a module having, as one of functions, a function of performing processing concerning a setting change of a Wi-Fi network of the terminal device 101.

In the above-mentioned configuration, as a result, there is an issue in which it is difficult for the user to recognize which apparatus is a targeted communication apparatus found by searching. To solve such an issue, the first embodiment is configured to perform predetermined processing for displaying an image to cause the user to recognize which apparatus is a targeted communication apparatus found by searching. The image to be displayed is, specifically, for example, an image representing an appearance of a model of the communication apparatus found by searching. Moreover, the predetermined processing is processing for invoking a second API different from the first API to cause the OS to perform searching. The second API is, specifically, a second API for causing a module called “AccessorySetupKit” included in the OS to perform searching. Furthermore, the details of AccessorySetupKit are described below. Furthermore, the second API is an API which is invoked based on program code “activate(on:eventHandler:)”.

### AccessorySetupKit

AccessorySetupKit is a module having a function of facilitating a setup for communicating with an accessory by Bluetooth or Wi-Fi in a terminal equipped with an OS with a version higher than or equal to iOS® 18 and iPadOS® 18. In the following description, AccessorySetupKit is referred to as an “ASK module”. Furthermore, in the first embodiment, the accessory is a communication apparatus which exists near the terminal device 101 and is capable of performing communication by Bluetooth or Wi-Fi. Moreover, the setup for communicating with an accessory is performed by the ASK module included in the OS acquiring accessory information corresponding to the accessory. The accessory information is information in which the entire text of an SSID corresponding to the accessory is included. In the following description, a function included in the ASK module is referred to as an “ASK function”. Here, the ASK function is described.

The ASK function is executed based on the ASK module having received an instruction from the predetermined application. Specifically, the ASK module receives, from the predetermined application, a character string representing at least a part of an SSID of the accessor targeted for searching and an image corresponding to the accessor targeted for searching. Then, the ASK function is executed based on the ASK module having received the above-mentioned character string and the above-mentioned image.

When having received an instruction for executing the ASK function from the predetermined application, the ASK module performs searching for an accessory corresponding to an SSID including the character string received from the predetermined application.

In searching for the accessory, specifically, the ASK module detects a beacon signal which an apparatus existing near the terminal device 101 is generating, and determines whether the character string notified from the predetermined application is included in an SSID included in the detected beacon signal. Then, the ASK module identifies, as an accessory found by searching, the apparatus which is generating the beacon signal including an SSID including the character string notified from the predetermined application.

After that, upon completion of searching for the accessory, the ASK module displays a screen representing a search result. The screen representing a search result includes the entire text of an SSID of the accessory found by searching and an image represented by image data corresponding to the found accessory. Furthermore, the entire text of an SSID of the accessory found by searching is included in the beacon signal detected in searching for the accessory and is, therefore, able to be identified by the ASK module. Moreover, the image data corresponding to the found accessory is image data notified from the predetermined application. Furthermore, in a case where a plurality of accessories corresponding to an SSID including the character string notified from the predetermined application has been found, the ASK module displays the above-mentioned screen in such a way as to enable the user to select any one of the plurality of accessories. Specifically, for example, in a case where, in a state in which an area for selecting a first accessory found by searching is currently displayed in the above-mentioned screen, the ASK module has received a slide operation from the user, the ASK module performs control in such a manner that a new area for selecting a second accessory found by searching is displayed in the above-mentioned screen.

Then, after a button for determining any one of the accessories found by the ASK module as an apparatus targeted for pairing has been operated, the ASK module transmits, to the predetermined application, accessory information corresponding to the accessory determined as an apparatus targeted for pairing. Furthermore, the pairing refers to bring the accessory into a state of being able to connect to the terminal device 101.

After that, the ASK module displays a screen indicating that the above-mentioned accessory has become available. The above-mentioned accessory having become available is equivalent to pairing with the above-mentioned accessory having been completed. Furthermore, the accessory which has been paired is managed as a paired accessory. The above-mentioned screen includes a “continue with application” button. If the “continue with application” button has been pressed, the ASK module notifies the predetermined application of ending an operation of the ASK module, and thus ends an operation of the ASK module.

### Processing which Predetermined Application Performs in First Embodiment

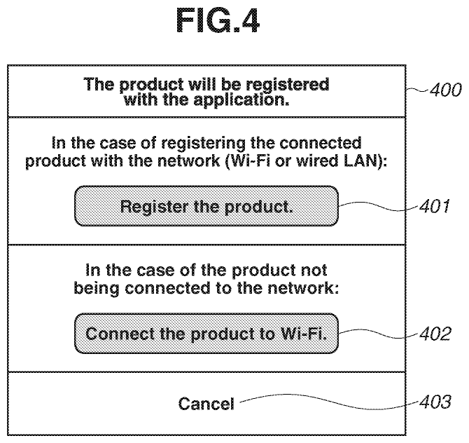

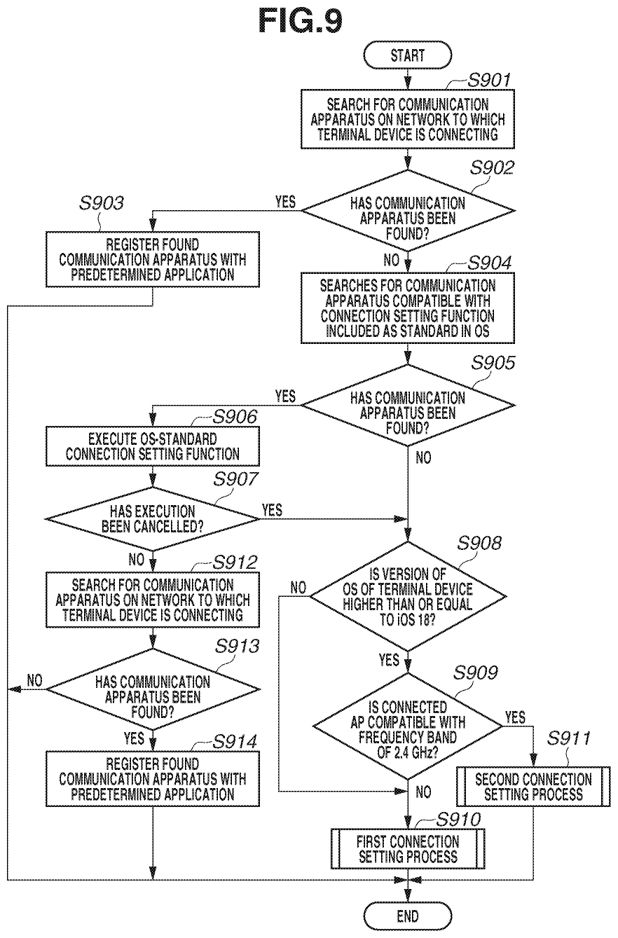

FIG. 9 is a flowchart illustrating an example of processing which the terminal device 101 performs to determine a method of connection setting process with use of the predetermined application in the first embodiment. Moreover, each processing operation in the flowchart of FIG. 9 is implemented by, for example, the CPU 103 loading the predetermined application stored in a memory such as the ROM 104 onto the RAM 105 and executing the predetermined application. Moreover, based on an operation for performing connection setting process having been performed on a screen which the predetermined application displays, the flowchart of FIG. 9 is started. Specifically, the screen which the predetermined application displays is a screen for registering the communication apparatus 151 with the predetermined application, and an example of such a screen is illustrated in FIG. 4. The screen 400 for registering the communication apparatus 151 with the predetermined application includes a button 401 for registering a communication apparatus the infrastructure setting information about which has already been acquired with the predetermined application, a button 402 for wirelessly transmitting the infrastructure setting information to the communication apparatus 151, and a cancel button 403. The button 401 for registering a communication apparatus the infrastructure setting information about which has already been acquired with the predetermined application is a button used for the predetermined application to search for the communication apparatus 151 on a Wi-Fi network to which the terminal device 101 is connecting. The button 402 for wirelessly transmitting the infrastructure setting information to the communication apparatus 151 is a button for performing the connection setting process for the communication apparatus 151. Based on the button 402 having been operated, the flowchart of FIG. 9 is started. Furthermore, the flowchart of FIG. 9 can be started in response to the predetermined application having been activated.

In step S901, via a Wi-Fi network to which the terminal device 101 is connecting, the predetermined application searches for a communication apparatus belonging to the Wi-Fi network by performing broadcast or multicast.

In step S902, the predetermined application determines whether a communication apparatus has been found by searching performed via the Wi-Fi network to which the terminal device 101 is connecting (searching performed in step S901). If the result of determination is YES (YES in step S902), the predetermined application advances the processing to step S903, and, if the result of determination is NO (NO in step S902), the predetermined application advances the processing to step S904.

In step S903, the predetermined application acquires information concerning the communication apparatus found by the performed searching from the communication apparatus via the Wi-Fi network to which the terminal device 101 is connecting, and then registers the found communication apparatus with the predetermined application. Furthermore, at this time, the predetermined application can automatically set the new registered communication apparatus as a currently selected communication apparatus. After that, the predetermined application ends the processing and then displays a home screen of the predetermined application.

In step S904, the predetermined application searches for a communication apparatus compatible with a connection setting function included as standard in the OS (hereinafter referred to as an “OS-standard connection setting function”). The OS-standard connection setting function is a function for transmitting infrastructure setting information to the communication apparatus 151, and is a function which is executed by a program preliminarily installed on the terminal device 101 and provided by an OS vendor of the terminal device 101 (hereinafter referred to as an “OS-standard program”). The OS-standard program is able to acquire, from the OS, information which is unable to be acquired by another application program (for example, a password for connecting to an AP). Therefore, in the OS-standard connection setting function, a password which has been input by the user for connection to the access point (AP) 131 and has been retained by the OS is automatically acquired from the OS by the OS-standard program, so that the password is transmitted to the communication apparatus 151. Therefore, the OS-standard connection setting function is, in other words, a function which enables the password to be transmitted to the communication apparatus 151, without the password being input to the terminal device 101 by the user, after the terminal device 101 has connected to the access point (AP) 131. For example, HyperText Transfer Protocol (HTTP) is used for a communication between the terminal device 101 and the communication apparatus 151 in the OS-standard connection setting function.

In step S905, the predetermined application determines whether a communication apparatus has been found by searching performed by the OS-standard connection setting function. If the result of determination is YES (YES in step S905), the predetermined application advances the processing to step S906, and, if the result of determination is NO (NO in step S905), the predetermined application advances the processing to step S908.

In step S906, the predetermined application executes the OS-standard connection setting function. Thus, the predetermined application activates the OS-standard program and causes the OS-standard program to execute the OS-standard connection setting function.

In step S907, the predetermined application determines whether the execution of the OS-standard connection setting function has been cancelled. If the predetermined application has received, from the OS-standard program, a notification indicating that the execution of the OS-standard connection setting function has been cancelled, the predetermined application determines the result of determination as YES, and, if the predetermined application has received, from the OS-standard program, a notification indicating that the execution of the OS-standard connection setting function has been completed, the predetermined application determines the result of determination as NO. Then, if the result of determination is YES (YES in step S907), the predetermined application advances the processing to step S908, and, if the result of determination is NO (NO in step S907), the predetermined application advances the processing to step S912.

In step S908, the predetermined application determines whether the version of the OS of the terminal device 101 is higher than or equal to a specific version. Furthermore, the specific version is a version of the OS compatible with the ASK module. Furthermore, in the first embodiment, the OS of the terminal device 101 is iOS or iPadOS. Then, the specific version is, specifically, any one of iOS 18 and iPadOS 18. If the result of determination is YES (YES in step S908), the predetermined application advances the processing to step S909, and, if the result of determination is NO (NO in step S908), the predetermined application advances the processing to step S910.

In step S909, the predetermined application determines whether the AP to which the terminal device 101 is connecting is compatible with a frequency band of 2.4 GHz. In this processing operation, if the result of determination is YES (YES in step S909), the predetermined application advances the processing to step S911. Moreover, if, since the AP to which the terminal device 101 is connecting is compatible with a frequency band of 5 GHz, the result of determination is NO (NO in step S909), the predetermined application advances the processing to step S910.

In step S910, the predetermined application performs first connection setting process. Moreover, in step S911, the predetermined application performs second connection setting process. The details of the first connection setting process and the second connection setting process are described below.

In step S912, which is performed in a case where the result of determination in step S907 is NO, as with step S901, the predetermined application searches for a communication apparatus via a Wi-Fi network to which the terminal device 101 is connecting.

After that, in step S913, the predetermined application determines whether a communication apparatus has been found by searching performed via the Wi-Fi network to which the terminal device 101 is connecting (searching performed in step S912). If the result of determination is YES (YES in step S913), the predetermined application advances the processing to step S914, and, if the result of determination is NO (NO in step S913), the predetermined application ends the processing and then displays a home screen of the predetermined application.

In step S914, as with step S903, the predetermined application registers the communication apparatus 151 found by searching performed in step S912 with the predetermined application. After that, the predetermined application ends the processing and then displays a home screen of the predetermined application.

As described above, in the first embodiment, by performing processing operations in step S908 and step S909, the predetermined application performs control as to whether to perform the first connection setting process or to perform the second connection setting process, based on a predetermined condition.

Furthermore, the predetermined condition is that the OS included in the terminal device 101 is an OS with a version higher than or equal to iOS 18 or iPadOS 18 or that the AP to which the terminal device 101 is connecting at the timing of step S909 is compatible with a frequency band of 2.4 GHz.

When any one of the processing operations in step S910 and step S911 has been completed, the predetermined application ends the processing and then displays a home screen of the predetermined application. Here, the reason the predetermined application performs control as to whether to perform the first connection setting process or to perform the second connection setting process according to whether the AP to which the terminal device 101 is connecting is compatible with a frequency band of 2.4 GHz is described. The second connection setting process is, in other words, connection setting process using information acquired by the ASK module. Furthermore, the connection setting process using information acquired by the ASK module has the following issue. In the first embodiment, to cause the communication apparatus 151 to connect to the AP by performing connection setting process, the terminal device 101 receives inputting of a password usable for connecting to the AP from the user via the predetermined application. Then, the terminal device 101 transmits the input password to the communication apparatus 151 via the predetermined application. Then, the communication apparatus 151 connects to the AP with use of the received password. In this way, in the first embodiment, the terminal device 101 is required to receive inputting of a password from the user via the predetermined application. At this time, while the user needs to confirm a password for the purpose of inputting the password, since a setting application or password application has the function of presenting a password to the user, the user may confirm the password from the setting application or password application.

Furthermore, the setting application or password application is an application different from the predetermined application. Moreover, the setting application or password application is an OS-standard application and is an application preliminarily installed on the terminal device 101 without being installed on the terminal device 101 by a store application. First, the setting application is also an application for performing various settings of the terminal device 101 and enables the execution of various settings including a Wi-Fi setting of the terminal device 101 or the management of a password of the AP. Next, the password application is an application preliminarily installed on the terminal device 101 equipped with an OS with a version higher than or equal to iOS 18 and iPadOS 18. Moreover, the password application enables the management of, in addition to a password of the AP, a password of a web site or application requiring password entry for login.

To confirm a password via the setting application or password application, the user needs to activate the setting application or password application and cause the activated application to transition to foreground. Therefore, for example, in a case where, in a state in which the predetermined application is running in foreground, an operation for activating the setting application or password application has been performed by the user, the predetermined application is caused to transition to background. The operation for activating the setting application or password application is, for example, an operation for displaying a home screen including an application icon for activating the setting application or an application icon for activating the password application, an operation for pressing a shortcut icon for activating the setting application or password application, or an operation for causing the setting application or password application which is running in background to transition to foreground. Furthermore, while, in the first embodiment, to cause the user to confirm a password of the AP, a configuration of prompting the user to confirm a password of the AP on the setting application is employed, the first embodiment is not limited to this configuration, and a configuration of prompting the user to confirm a password of the AP on the password application can be employed.

Furthermore, with regard to a Wi-Fi connection between the terminal device 101 and the communication apparatus 151 established by an instruction issued to the OS by the predetermined application without use of information acquired by the ASK module, the predetermined application is able to perform control in such a way as to prevent the established Wi-Fi connection from being severed even if a predetermined time has elapsed after the predetermined application has transitioned to background. However, with regard to a Wi-Fi connection between the terminal device 101 and the communication apparatus 151 established by an instruction issued to the OS by the predetermined application with use of information acquired by the ASK module, the predetermined application is unable to perform control in such a way as to prevent the established Wi-Fi connection from being severed even if a predetermined time has elapsed after the predetermined application has transitioned to background. Thus, the Wi-Fi connection between the terminal device 101 and the communication apparatus 151 which is established based on information acquired by the ASK module is a connection which is unable to be controlled by processing which the predetermined application performs in such a way as to prevent the connection from being severed even if the predetermined application is caused to transition to background. As a result, the Wi-Fi connection between the terminal device 101 and the communication apparatus 151 established by an instruction issued to the OS by the predetermined application with use of information acquired by the ASK module is necessarily severed based on a predetermined time having elapsed after the predetermined application has transitioned to background. Thus, in a configuration using the ASK function to establish a connection between the terminal device 101 and the communication apparatus 151, there is an issue in which, if the predetermined application is caused to transition to background by the reason that, for example, the user activates the setting application to perform password confirmation after the Wi-Fi connection has been established based on information acquired by the ASK module, the Wi-Fi connection may be severed. Furthermore, if the Wi-Fi connection between the terminal device 101 and the communication apparatus 151 is severed, even if the predetermined application has returned to foreground again, the predetermined application becomes unable to perform connection setting of the communication apparatus 151.

In the flowchart, the AP to which the terminal device 101 is connecting at timing of step S909 can be identified as an AP serving as a connection target for the communication apparatus 151. Then, as described below, in the first embodiment, the predetermined application acquires, from the communication apparatus 151, a list of APs found by searching performed by the communication apparatus 151. Then, the predetermined application determines whether an AP serving as a connection target for the communication apparatus 151 is included in the acquired list. In the second connection setting process, as mentioned above, it is desired that a situation in which an AP serving as a connection target for the communication apparatus 151 is not included in the above-mentioned list does not occur. In other words, it is desired that a situation in which an AP the password of which has already been confirmed is not included in the above-mentioned list does not occur. Thus, since the user is unable to select an AP the password of which has already been confirmed and has no choice but to select any AP from the APs included in the above-mentioned list, after a predetermined connection between the terminal device 101 and the communication apparatus 151 has been established, the user needs to confirm again the password of an AP which the user has selected from the AP list with use of the setting application. When, to confirm the password with use of the setting application, the user activates the setting application, the predetermined application is caused to transition to background. As a result, the predetermined connection may be severed and the connection setting process may fail. Furthermore, the predetermined connection is a Wi-Fi connection which is unable to be controlled by the processing which the predetermined application performs, in such a way as not to be severed even if the predetermined application is caused to transition to background. Moreover, the predetermined connection is a Wi-Fi connection which is established with use of information acquired by the ASK module. Therefore, in the first embodiment, in the following description, a Wi-Fi connection between the terminal device 101 and the communication apparatus 151 that is based on information acquired by the ASK module is referred to as a “predetermined connection”.

However, for example, there is a case where a communication apparatus is capable of performing communication with 2.4 GHz but incapable of performing communication with 5 GHz. In this case, in a list of APs represented by the acquired information, an AP compatible with communication using 2.4 GHz is included, but an AP compatible with communication using 5 GHz is not included. As a result, if, due to an AP to which the terminal device 101 is connecting at timing of execution of step S909 being compatible with a frequency band of 5 GHz, the AP compatible with a frequency band of 5 GHz is unfavorably identified as an AP serving as a connection target for the communication apparatus 151, a situation in which an AP serving as a connection target for the communication apparatus 151 is not included in the above-mentioned list occurs. Therefore, performing the second connection setting process in a case where an AP to which the terminal device 101 is connecting at timing of execution of step S909 is compatible with a frequency band of 2.4 GHz enables preventing or reducing a situation in which an AP serving as a connection target for the communication apparatus 151 is not included a list of APs acquired from the communication apparatus 151 from occurring. Eventually, it is possible to prevent or reduce confirming the password of an AP again or inputting the password after the predetermined connection. Thus, it is possible to prevent or reduce the predetermined application from being caused to transition to background due to the password confirmation of an AP identified as a connection target for the communication apparatus 151.

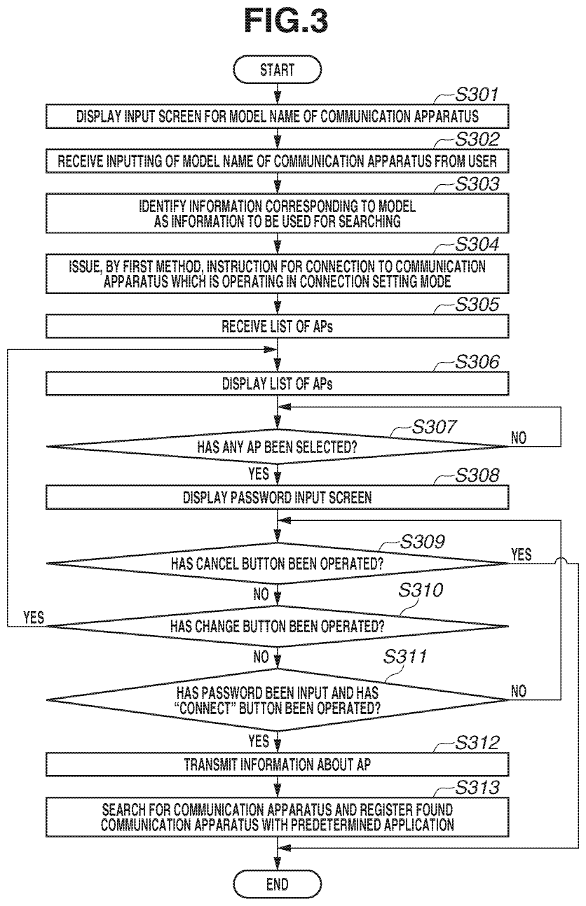

FIG. 3 is a flowchart illustrating an example of the first connection setting process in the first embodiment.

Each processing operation in the flowchart of FIG. 3 is implemented by, for example, the CPU 103 loading the predetermined application stored in a memory such as the ROM 104 onto the RAM 105 and executing the predetermined application. The processing in the flowchart corresponds to the processing operation in step S910.

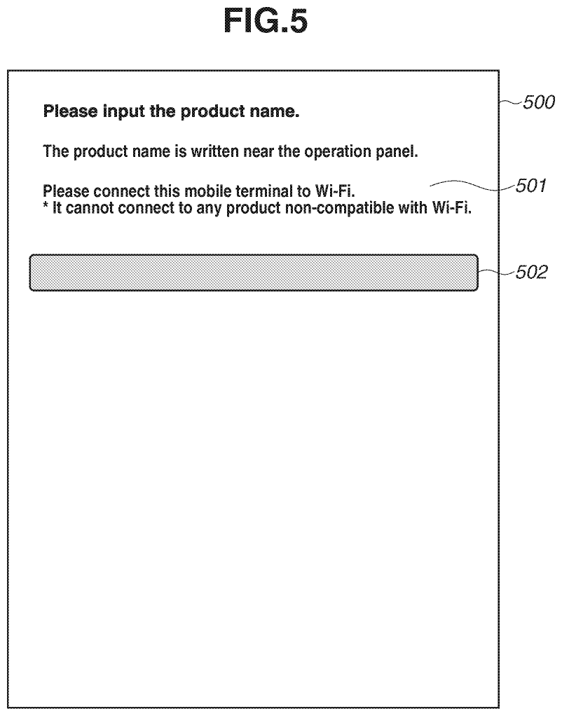

In step S301, the predetermined application displays a model name input screen for receiving, from the user, inputting of a model name of a communication apparatus targeted for searching. An example of a screen which is displayed in the processing operation is illustrated in FIG. 5. The model name input screen 500 includes a region 501 indicating the display position of the model name and a model name inputting box 502. In the region 501, as a sentence representing the display position of the model name, for example, a sentence “The product name is written near the operation panel.” is displayed. Furthermore, the product name included in the above-mentioned sentence is equivalent to the model name of a communication apparatus. The model name inputting box 502 is a region for receiving, from the user, inputting of at least a part of a character string of the model name of a communication apparatus targeted for searching. Evey time the predetermined application receives, from the user, inputting of at least a part of a character string of the model name of a communication apparatus targeted for searching to the model name inputting box 502, the predetermined application displays, below the model name inputting box 502, a list of model names serving as candidates according to the input contents.

In step S302, the predetermined application receives inputting of a model name of the communication apparatus from the user. Specifically, the predetermined application receives inputting of at least a part of a character string of the model name of a communication apparatus targeted for searching to the model name inputting box 502. Then, in the state of having received, from the user, inputting of at least a part of a character string of the model name of a communication apparatus targeted for searching, based on the user having selected any model name from a list of model names, the predetermined application identifies a model name of the communication apparatus targeted for searching.

Furthermore, in step S301, the predetermined application does not need to receive inputting to the model name inputting box 502 from the user. In this configuration, for example, in the screen 500, the predetermined application does not display the model name inputting box 502 but displays a list of model names. Then, in step S302, based on the user having selected any model name from the list of model names, the predetermined application identifies a model name of the communication apparatus targeted for searching.

In step S303, the predetermined application identifies information corresponding to the model as information to be used for searching for a communication apparatus which is performed by the OS. As mentioned above, in the first embodiment, the predetermined application preliminarily retains a plurality of character strings allocated for each model name. Therefore, in the processing operation, the predetermined application identifies, as information corresponding to the model, a character string corresponding to the model name identified in step S302 from among the above-mentioned plurality of character strings. The character string to be identified here is a character string of at least a part of the character string constituting the SSID of a connection setting AP which the apparatus with the model name identified in step S302 enables at the time of the connection setting mode, and is a model-by-model common character string. Moreover, in the processing operation, the information corresponding to the model includes a character string indicating a model name identified based on the input received from the user in step S302.

Moreover, the predetermined application does not need to preliminarily retain a plurality of character strings allocated for each model name. In this configuration, every time the predetermined application receives, from the user, inputting of at least a part of a character string of the model name of a communication apparatus targeted for searching to the model name inputting box 502 in the screen 500, the predetermined application does not need to display a list of model names serving as candidates according to the input contents, or does not need to identify a model name in step S302. Instead, in this configuration, the predetermined application receives, from the user, inputting of the entire text of a character string of the model name of a communication apparatus targeted for searching to the model name inputting box 502 in the screen 500. Then, in step S303, the predetermined application identifies the character string itself received from the user as information corresponding to the model.

In step S304, the predetermined application performs, by a first method, processing for establishing a connection between the communication apparatus 151 which is operating in the connection setting mode and the terminal device 101. The first method is a method in which, to instruct the OS to establish a connection between the communication apparatus 151 which is operating in the connection setting mode and the terminal device 101, the predetermined application invokes the above-mentioned first API. Specifically, while setting, as an argument, a character string of at least a part of the SSID of the communication apparatus 151 which is operating in the connection setting mode, the predetermined application invokes the first API for establishing a connection of the terminal device 101. In the processing operation, the character string of at least a part of the SSID of the communication apparatus 151 which is operating in the connection setting mode is information corresponding to the model identified in step S303. The information corresponding to the model identified in step S303 is, specifically, equivalent to a character string representing the model name identified based on an input received from the user in step S302. Furthermore, in the first embodiment, a configuration in which, in the SSID of the communication apparatus 151 which is operating in the connection setting mode (SSID of the connection setting AP), only a model-by-model common character string is included can be employed. In that configuration, the character string identified in step S303 is equivalent to the SSID of the communication apparatus 151 which is operating in the connection setting mode. Therefore, in that configuration, while setting, as an argument, not a part of but the entire text of the SSID of the communication apparatus 151 which is operating in the connection setting mode, the predetermined application can invoke the first API for establishing a connection of the terminal device 101.

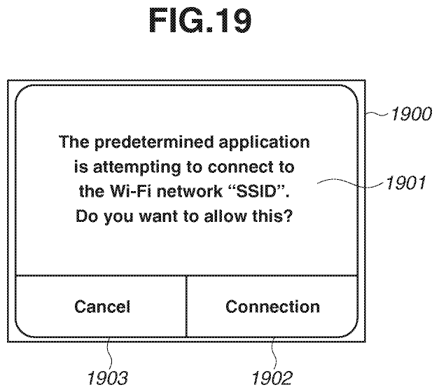

Thereupon, the OS searches for an apparatus having an SSID including the character string concerned and, when having found the apparatus, displays a search result. Then, the OS displays, in a screen showing the search result, identification information corresponding to the apparatus found by searching (i.e., the communication apparatus 151 which is operating in the connection setting mode) as text only. Then, based on a connection button 1902 described below having been operated, the OS establishes a connection between the communication apparatus 151 which is operating in the connection setting mode and the terminal device 101. A screen which the OS displays in the processing operation is illustrated in FIG. 19. The screen 1900 includes a region 1901 for connection confirmation, the connection button 1902, and a cancel button 1903. In the region 1901, a sentence used for the predetermined application to confirm a connection between the communication apparatus 151 which is operating in the connection setting mode and the terminal device 101 is displayed, and, in the displayed sentence, text of identification information corresponding to the communication apparatus 151 which is operating in the connection setting mode is included. Furthermore, the communication apparatus 151 to which the terminal device 101 connects by the processing operation is equivalent to a model corresponding to the model name identified based on the input received from the user in step S302. Moreover, the communication apparatus 151 to which the terminal device 101 connects by the processing operation is assumed to be a communication apparatus which has been found first by searching performed by the processing operation in step S304.

Furthermore, in the first embodiment, as a connection of the terminal device 101 which is established by an instruction from the predetermined application, the predetermined application establishes a connection which is not severed even if the predetermined application is caused to transition to background. The established connection is maintained without being severed by the OS even if a predetermined time has elapsed while the predetermined application has been caused to transition to background. Specifically, in step S304, while setting a flag for instructing the OS to establish the connection, the predetermined application invokes the first API. This causes the OS to establish a connection between the communication apparatus 151 which is operating in the connection setting mode and the terminal device 101. This causes a connection between the communication apparatus 151 which is operating in the connection setting mode and the terminal device 101 not to be severed, even if a predetermined time has elapsed after the predetermined application has operated in background.

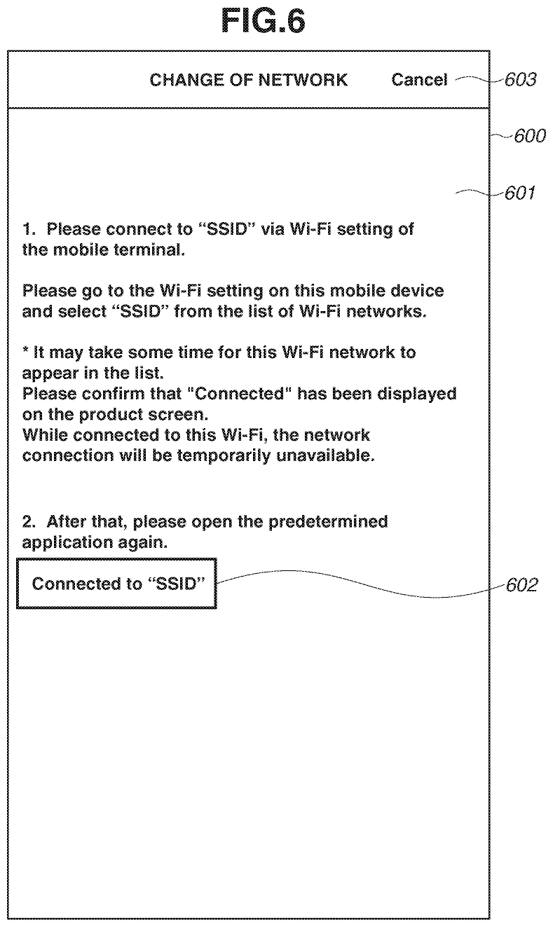

Furthermore, in the processing operation, in a case where no communication apparatus has been found by searching for communication apparatuses performed by the OS, on a Wi-Fi setting screen which is displayed by the setting application, the predetermined application displays a screen for prompting the user to select the SSID of a communication apparatus which is operating in the connection setting mode. An example of this screen is illustrated in FIG. 6. The screen 600 includes a region 601 representing a method for connecting to a communication apparatus which is operating in the connection setting mode, a button 602 which is operated in a case where the selection of the SSID of the communication apparatus which is operating in the connection setting mode has been completed, and a cancel button 603. In the region 601, sentences for prompting the user to select the SSID of a communication apparatus which is operating in the connection setting mode on a Wi-Fi setting screen which is displayed by the setting application are displayed. The user, when having confirmed the displayed sentences, activates the setting application via, for example, a home screen of the terminal device 101 and then performs an operation which are represented by the sentences, thus causing the terminal device 101 to connect to a communication apparatus which is operating in the connection setting mode. Then, after causing the terminal device 101 to connect to the communication apparatus, which is operating in the connection setting mode, the user causes the predetermined application to operate in foreground again and then operates the button 602. After the button 602 has been operated, the predetermined application advances the processing to step S305.

In step S305, the predetermined application acquires, from the communication apparatus 151, information about a list of APs found by searching which the communication apparatus 151 has performed. The APs found by searching which the communication apparatus 151 has performed are APs to which the communication apparatus 151 is able to connect. The APs to which the communication apparatus 151 is able to connect are APs which are located within a range in which the communication apparatus 151 is able to perform communication and are APs compatible with the capability of the communication apparatus 151. For example, in a case where the communication apparatus 151 is capable of performing communication with 2.4 GHz but is incapable of performing communication with 5 GHz, in the list of APs represented by the acquired information, APs compatible with 2.4 GHz are included but APs compatible with 5 GHz are not included.

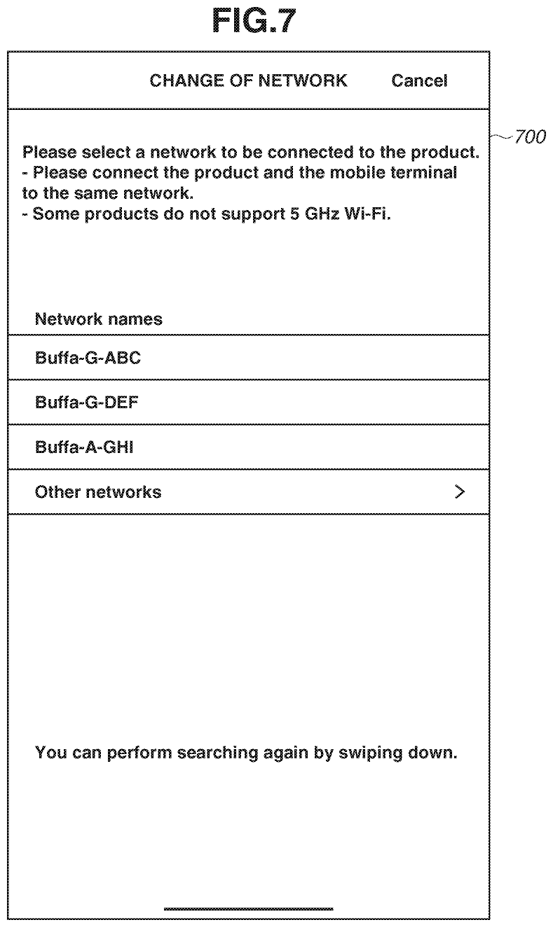

In step S306, the predetermined application displays a list of APs represented by the information acquired in step S305. An example of a screen which is displayed by the processing operation is illustrated in FIG. 7. In the screen 700 for displaying an AP list, a list of APs represented by the information acquired in step S305 is displayed. In the first embodiment, in a case where, in the displayed list, there is an AP which the user desires as a connection target for the communication apparatus 151, the desired AP is identified as a connection target for the communication apparatus 151.

In step S307, the predetermined application determines whether any AP has been selected by the user from the displayed list of APs. If the result of determination is YES (YES in step S307), since the AP selected from the list of APs is identified as a connection target for the communication apparatus 151, the predetermined application advances the processing to step S308, and, if the result of determination is NO (NO in step S307), the predetermined application returns the processing to step S307 and thus waiting for receiving selection of any AP in the screen for displaying the list of APs.

In step S308, the predetermined application displays a password input screen for receiving inputting of a password used for connecting to the AP identified as a connection target for the communication apparatus 151.

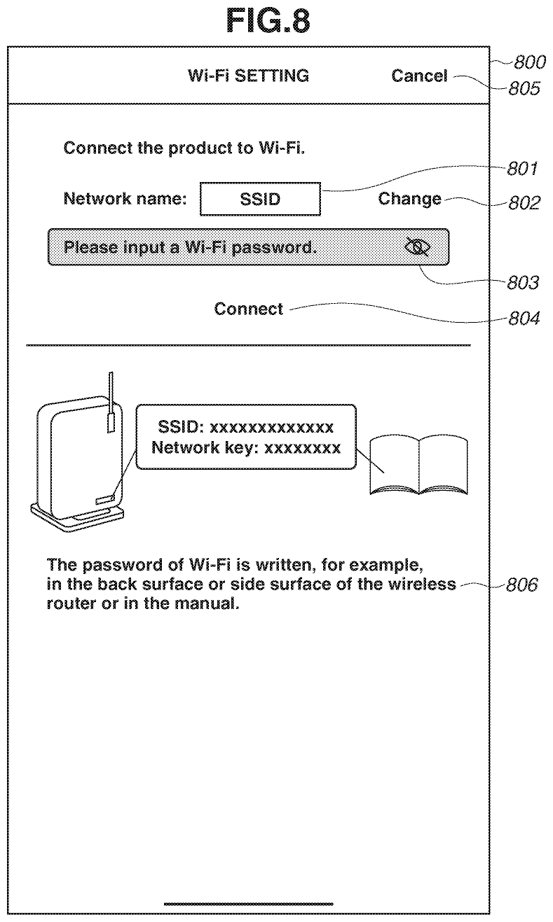

Furthermore, the password input screen can be displayed in a pop-up window above the list of APs. An example of a screen which is displayed in the processing operation is illustrated in FIG. 8. The password input screen 800 includes an SSID display region 801, a change button 802, a password inputting box 803, a “connect” button 804, a cancel button 805, and a region 806 representing a writing location of a password of the AP identified as a connection target for the communication apparatus 151. The SSID display region 801 is a region for displaying the SSID of the AP identified as a connection target for the communication apparatus 151. The change button 802 is a button for changing the AP identified as a connection target for the communication apparatus 151. The password inputting box 803 is a region for receiving, from the user, inputting of a password of an AP identified as a connection target for the communication apparatus 151. Furthermore, the AP identified as a connection target is an AP selected from the list of APs displayed in step S306. The region 806 representing a writing location of a password of the AP identified as a connection target for the communication apparatus 151 is a region representing a location at which to confirm the above-mentioned password of the AP while the predetermined application has been kept in foreground. For example, as the writing location of the password of the AP, the main body of a wireless router or a manual of the wireless router is indicated.

In step S309, the predetermined application determines whether the cancel button 805 has been operated. If the result of determination is YES (YES in step S309), the predetermined application ends the processing, and, if the result of determination is NO (NO in step S309), the predetermined application advances the processing to step S310.

In step S310, the predetermined application determines whether the change button 802 has been operated. If the result of determination is YES (YES in step S310), the predetermined application returns the processing to step S306, thus waiting for receiving any operation in the screen for displaying the AP list, and, if the result of determination is NO (NO in step S310), the predetermined application advances the processing to step S311.

In step S311, the predetermined application determines whether, in a state in which a password has been input to the password inputting box 803, a user operation on the “connect” button 804 has been received. If the result of determination is YES (YES in step S311), the predetermined application advances the processing to step S312, and, if the result of determination is NO (NO in step S311), the predetermined application returns the processing to step S309 thus waiting for receiving any operation in the password input screen 800 from the user.

In step S312, the predetermined application transmits, to the communication apparatus 151, information for connecting to the AP identified as a connection target for the communication apparatus 151. The information to be transmitted here includes, specifically, the password input to the password inputting box 803 and the SSID of the AP identified as a connection target for the communication apparatus 151. Furthermore, the AP identified as a connection target is an AP selected from the list of APs displayed in step S306. Furthermore, after the information for connecting to the AP identified as a connection target for the communication apparatus 151 has been transmitted to the communication apparatus 151, the communication apparatus 151 ends the connection setting mode and, with use of the received information, connects to the AP identified as a connection target for the communication apparatus 151. Furthermore, in response to the connection setting mode being ended, a connection between the communication apparatus 151 and the terminal device 101 is also severed. Due to the reconnection function of the OS, the terminal device 101 reconnects to an AP to which the terminal device 101 has been previously connecting before connecting to the communication apparatus 151. Furthermore, the AP to which the terminal device 101 has been previously connecting before connecting to the communication apparatus 151 is, in other words, an AP to which the terminal device 101 is connecting by Wi-Fi at the start timing of the flowchart of FIG. 3. In the following description, the AP to which the terminal device 101 is connecting by Wi-Fi at the start timing of the flowchart of FIG. 3 is referred to as a “predetermined AP”. After that, the predetermined application advances the processing to step S313.

In step S313, the predetermined application searches for a communication apparatus 151 via a Wi-Fi network to which the terminal device 101 is connecting. For example, in a case where the AP identified as a connection target for the communication apparatus 151 is the predetermined AP, since both the communication apparatus 151 and the terminal device 101 connect to the predetermined AP, the communication apparatus 151 is found by the searching. However, in a case where the communication apparatus 151 has connected to an AP other than the predetermined AP or in case where the communication apparatus 151 has failed in connection to an AP due to the input password being incorrect, the communication apparatus 151 is not found by the searching. In a case where the communication apparatus 151 has been found by the searching, the terminal device 101 acquires, from the communication apparatus 151, information concerning the communication apparatus 151 via a Wi-Fi network to which the terminal device 101 is connecting, and then registers the communication apparatus 151 with the predetermined application. Furthermore, at this time, the predetermined application can automatically set the new registered communication apparatus 151 as a currently selected communication apparatus 151. After that, the predetermined application ends the processing, and then displays a home screen of the predetermined application.

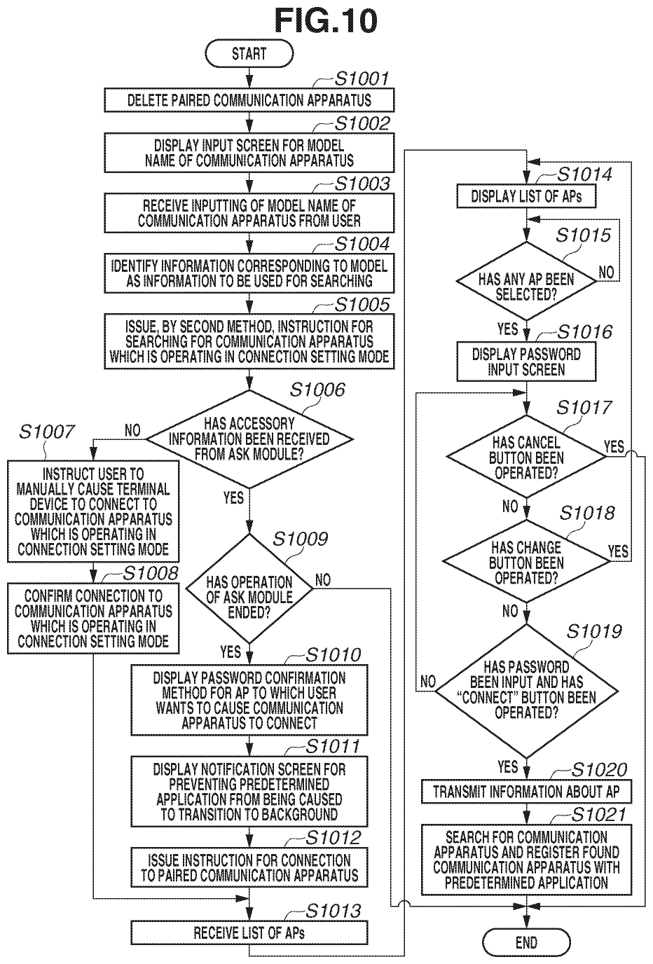

FIG. 10 is a flowchart illustrating an example of the second connection setting process in the first embodiment. Furthermore, each processing operation in the flowchart of FIG. 10 is implemented by, for example, the CPU 103 loading the predetermined application stored in a memory such as the ROM 104 onto the RAM 105 and executing the predetermined application.

In step S1001, the predetermined application causes the setting application to delete information for managing an accessory as a paired accessory and thus performs control in such a manner that the paired accessory is handled as an unpaired accessory. Furthermore, in execution of the ASK function, a communication apparatus which has been managed as a paired accessory is not found by the ASK module at the time of searching for accessories in the feature. Therefore, before searching for accessories, the predetermined application instructs the ASK module to delete a paired communication apparatus. As a result, a communication apparatus which has been managed as a paired accessory is deleted from a list of paired accessories which is displayed by the setting application.

Steps S1002 and S1003 are similar to steps S301 and S302 and are, therefore, omitted from description here.

In step S1004, the predetermined application identifies information corresponding to the model as information to be used for searching for a communication apparatus which is performed by the ASK module. In the processing operation, the information corresponding to the model includes a character string representing a model name identified based on an input received from the user in step S1003 and image data corresponding to the model concerned. As mentioned above, in the first embodiment, the predetermined application preliminarily retains a plurality of character strings allocated for each model name. Therefore, in the processing operation, the predetermined application identifies, as information corresponding to the model, a character string corresponding to the model name identified in step S1003. The character string to be identified here is a character string of at least a part of a character string constituting the SSID of a connection setting AP which an apparatus with the model name identified in step S1003 enables at the time of the connection setting mode, and is a model-by-model common character string. Additionally, in the first embodiment, the predetermined application preliminarily retains a plurality of pieces of image data allocated for each model name. Therefore, in the processing operation, the predetermined application identifies, as information corresponding to the model, image data corresponding to the model name identified in step S1003 from among the above-mentioned plurality of pieces of image data. Furthermore, the image data to be identified does not need to be image data which the predetermined application preliminarily retains. For example, in step S1004, the predetermined application can notify, via the Internet, an external server of the model name identified in step S1003 and acquire, via the Internet, image data corresponding to the model name from the external server.

In step S1005, the predetermined application issues, by a second method, an instruction for searching for a communication apparatus which is operating in the connection setting mode. The second method is a method in which, to instruct the ASK module to search for a communication apparatus 151 which is operating in the connection setting mode, the predetermined application invokes a second API different from the first API. In the processing operation, the predetermined application instructs the ASK module to execute the ASK function. At the timing of this instruction, the predetermined application notifies the ASK module of the character string identified in step S1004 and the image data identified in step S1004. Furthermore, the communication apparatus 151 which is operating in the connection setting mode is equivalent to a model corresponding to the model name identified based on the input received from the user in step S1003.

Furthermore, as mentioned above, a configuration in which, in the SSID of the communication apparatus 151 which is operating in the connection setting mode, only a model-by-model common character string is included can be employed. In that configuration, the character string identified in step S1004 is equivalent to the SSID of the communication apparatus 151 which is operating in the connection setting mode. Therefore, in that configuration, while setting, as an argument, not a part of but the entire text of the SSID of the communication apparatus 151 which is operating in the connection setting mode, the predetermined application can invoke the second API for searching for the communication apparatus 151.

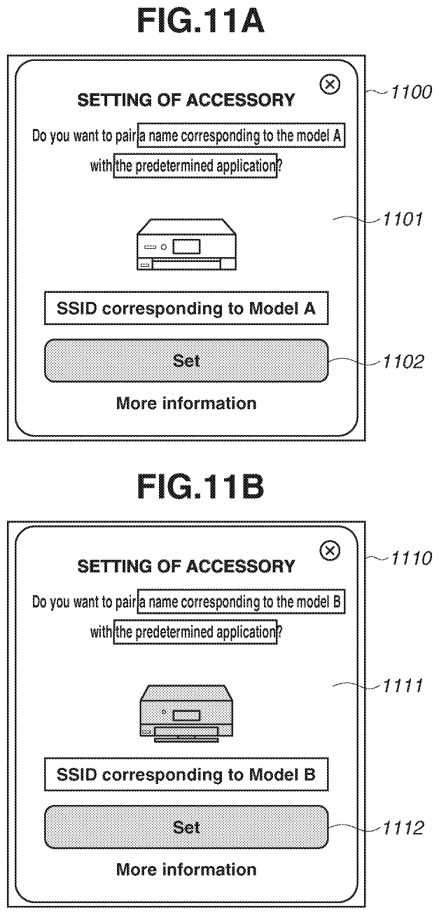

In step S1006, the predetermined application determines whether accessory information has been received from the ASK module. If the result of determination is YES (YES in step S1006), a screen representing the search result is displayed by the ASK module. Examples of a screen representing the search result are illustrated in FIGS. 11A and 11B. The screen 1100 is a screen which is displayed based on a model A having been found by searching performed by the ASK module. The screen 1100 includes a region 1101 in which a name corresponding to the model A, an image corresponding to the model A, and the entire text of an SSID corresponding to the model A are displayed and a button 1102 for determining the model A, which is an apparatus found by the ASK module, as an apparatus targeted for pairing. Furthermore, in the first embodiment, the name which is displayed in the search result screen is a name corresponding to an accessory targeted for searching. Thus, the name which is displayed in the search result screen is equivalent to a name of which the predetermined application has notified the ASK module at timing when the predetermined application instructs the ASK module to search for the communication apparatus 151 which is operating in the connection setting mode. Furthermore, the entire text of an SSID corresponding to the model A is included in accessory information which the ASK module has acquired based on an accessory having been found by searching. Furthermore, the image corresponding to the model A is image data corresponding to a model identified based on the input received from the user in step S1003 and is an image which is represented by image data of which the predetermined application has notified the ASK module in step S1005. Therefore, based on the model A having been identified by the user in step S1003, then in step S1005, the predetermined application notifies the ASK module of image data corresponding to the model A. Then, in the screen 1100, an image which is represented by the image data corresponding to the model A is displayed. The screen 1110 is a screen which is displayed based on a model B having been found by searching performed by the ASK module. The screen 1110 includes a region 1111 in which a name corresponding to the model B, an image corresponding to the model B, and the entire text of an SSID corresponding to the model B are displayed and a button 1112 for determining the model B, which is an apparatus found by the ASK module, as an apparatus targeted for pairing. Furthermore, the entire text of an SSID corresponding to the model B is included in accessory information which the ASK module has acquired based on an accessory having been found by searching. Furthermore, the image corresponding to the model B is image data corresponding to a model identified based on the input received from the user in step S1003 and is an image which is represented by image data of which the predetermined application has notified the ASK module in step S1005. Therefore, based on the model B having been identified by the user in step S1003, then in step S1005, the predetermined application notifies the ASK module of image data corresponding to the model B. Then, in the screen 1110, an image which is represented by the image data corresponding to the model B is displayed. Thus, the predetermined application changes over an image which is displayed in the screen for displaying a search result, in association with a model identified based on inputting of a model name of the communication apparatus being received from the user in step S1003.

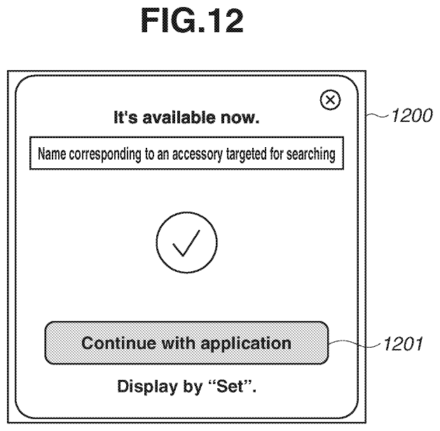

In response to the button 1102 being operated, the ASK module displays a screen indicating that the above-mentioned accessary has become available. An example of the screen is illustrated in FIG. 12. The screen 1200 includes a “continue with application” button 1201. In response to the button 1201 being operated, the ASK module notifies the predetermined application of ending an operation of the ASK module, thus ending an operation of the ASK module. If the result of determination is YES (YES in step S1006), the predetermined application advances the processing to step S1009, and, if the result of determination is NO (NO in step S1006), the predetermined application advances the processing to step S1007.

In step S1007, which is performed in a case where the result of determination in step S1006 is NO, the predetermined application instructs the user to manually cause the terminal device 101 to connect to a communication apparatus which is operating in the connection setting mode. Specifically, on a Wi-Fi setting screen which is displayed by the setting application, the predetermined application displays a screen for prompting the user to select the SSID of a communication apparatus which is operating in the connection setting mode. An example of this screen is illustrated in FIG. 6. The details of the screen illustrated in FIG. 6 have been described above with regard to step S304 and are, therefore, omitted from description here.

In step S1008, the predetermined application confirms the connection to the communication apparatus, which is operating in the connection setting mode, which the user has manually performed. Specifically, the predetermined application confirms the connection to the communication apparatus, which is operating in the connection setting mode, based on the button 602 having been operated by the user. After the processing operation in step S1008 is performed, the predetermined application advances the processing to step S1013, without performing processing for displaying a method of password confirmation of an AP to which the user wants to perform connection, processing for displaying a notification screen for preventing or reducing the predetermined application from transitioning to background, and processing for issuing an instruction for connecting to the paired communication apparatus, such as those in step S1009 to step S1012.

In step S1009, which is performed in a case where the result of determination in step S1006 is YES, the predetermined application determines whether an operation of the ASK module has ended. Specifically, the predetermined application determines whether the “continue with application” button 1201 has been operated and a notification indicating ending an operation of the ASK module has been received from the ASK module. If the notification has been received, the predetermined application determines that an operation of the ASK module has ended, and, if the notification has not been received, the predetermined application determines that an operation of the ASK module has not ended. If the result of determination in step S1009 is YES (YES in step S1009), the predetermined application advances the processing to step S1010. If the result of determination in step S1009 is NO (NO in step S1009), the predetermined application ends the processing, and then displays a home screen thereof.

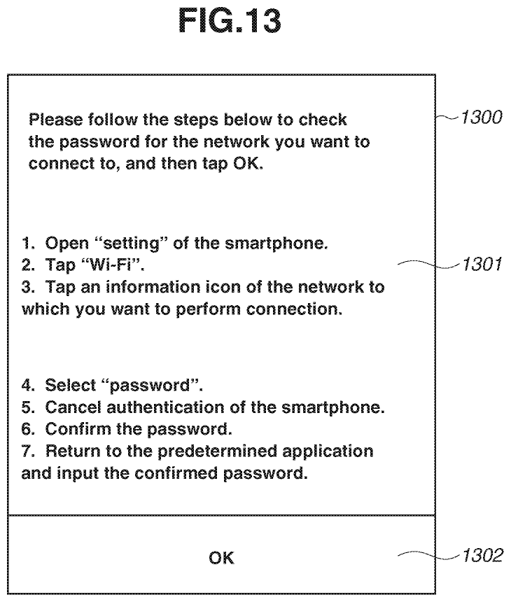

In step S1010, the predetermined application displays a screen for confirming a password of an AP to which the user wants to cause the communication apparatus to connect. An example of a screen which is displayed in the processing operation is illustrated in FIG. 13. The screen 1300 includes a region 1301 representing a method for confirming the password of the AP on a Wi-Fi setting screen which is displayed by the setting application (hereinafter referred to as a “password confirmation method”) and an OK button 1302. In the region 1301, as a sentence representing the password confirmation method, a sentence representing an operation for confirming the password on the Wi-Fi setting screen is displayed. Moreover, in the region 1301, a sentence for prompting the user to, after confirming the password, return to the predetermined application (cause the predetermined application to transition to foreground again) can be displayed. The user, when having confirmed the displayed sentence, activates the setting application from, for example, the home screen of the terminal device 101 and performs an operation represented by the sentence, thus confirming the password. Then, after confirming the password, the user causes the predetermined application to operate in foreground again, operates the button 1302, and then inputs the password on the predetermined application. Moreover, in a terminal device equipped with iOS or iPadOS, it is impossible to activate the setting application by an instruction from the predetermined application. Therefore, the screen 1300 is assumed not to include a button for displaying a Wi-Fi setting screen. However, the first embodiment is not limited to this configuration, even in a terminal device equipped with iOS or iPadOS, if it becomes possible to activate the setting application by an instruction from the predetermined application, a button for displaying a Wi-Fi setting screen can also be included in the screen 1300. If the button 1302 has been operated, the predetermined application advances the processing to step S1011.

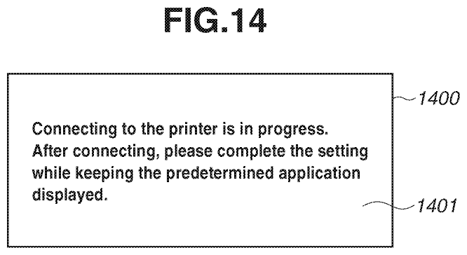

In step S1011, the predetermined application displays a notification screen for, in a predetermined period, preventing the predetermined application from being caused to transition to background. Furthermore, the predetermined period is a period including at least a part of a period in which a predetermined connection between the terminal device 101 and the communication apparatus 151 is maintained. Furthermore, the predetermined period can also include a period other than the period in which the predetermined connection is maintained. FIG. 14 illustrates a notification screen which is displayed in the predetermined application to prevent the predetermined application from being caused to transition to background. The screen 1400 includes a region 1401 in which a sentence for preventing the predetermined application from being caused to transition to background is displayed. In the notification screen, for example, a sentence “After connecting, please complete the setting while keeping the predetermined application displayed.” may be displayed. In this case, the predetermined period is equivalent to a period until a predetermined connection is established after the notification screen is displayed and a period including a period of at least a part of a period in which the predetermined connection is maintained. Moreover, in the notification screen, for example, a sentence “Please keep the predetermined application displayed until the setting is complete.” may be displayed. In this case, the predetermined period is equivalent to a period including a period of at least a part of a period in which the predetermined application is maintained after the notification screen is displayed. Furthermore, the timing of the notification screen which the predetermined application displays is not limited to the timing at which the processing operation is performed. For example, the timing of the notification screen can be the timing at which to display a password confirmation method for the AP for which the user wants connection, the timing at which to issue an instruction for connection to the paired communication apparatus, or after the timing at which to issue an instruction for connection to the paired communication apparatus. Moreover, the notification screen can be a screen for notifying the user in such a way as to prevent the predetermined application from being caused to transition to background.

In step S1012, the predetermined application instructs the ASK module to establish a connection between the communication apparatus 151, which is a paired accessory, and the terminal device 101.

Specifically, the predetermined application notifies the network setting module of the accessory information received from the ASK module in step S1006 and invokes a third API for establishing a connection to the terminal device 101, thus issuing the above-mentioned instruction. Furthermore, the above-mentioned third API is an API different from the first API, which is invoked to establish a connection between the terminal device 101 and the communication apparatus 151 in the first connection setting process. Moreover, the above-mentioned third API is an API different from the second API, which is invoked for accessory search in the second connection setting process. Furthermore, the third API is an API which is invoked based on program code “joinAccessoryHotspotWithoutSecurity(_:completionHandler:)”.

In step S1013, the predetermined application acquires, from the communication apparatus 151, information about a list of APs found by searching performed by the communication apparatus 151. The APs found by searching performed by the communication apparatus 151 have been described above in detail with regard to step S305 and are, therefore, omitted from description here.

In step S1014, as with step S306, the predetermined application displays a list of APs represented by the information acquired in step S1013. In a case where, in the displayed list, there is an AP which the user desires as a connection target for the communication apparatus 151, the desired AP is identified as a connection target for the communication apparatus 151.

In step S1015, the predetermined application determines whether any AP has been selected by the user from the displayed list of APs. If the result of determination is YES (YES in step S1015), since the AP selected from the list of APs is identified as a connection target for the communication apparatus 151, the predetermined application advances the processing to step S1016. Then, if the result of determination is NO (NO in step S1015), the predetermined application returns the processing to step S1015 and thus waiting for receiving any operation.

In step S1016, the predetermined application displays a password input screen for receiving inputting of a password used for connecting to the AP identified as a connection target for the communication apparatus 151. Furthermore, the password input screen can be displayed in a pop-up window above the list of APs. An example of a screen which is displayed in the processing operation is illustrated in FIG. 8. The details of the screen 800 have been described above with regard to the processing operation in step S308 and are, therefore, omitted from description here. Furthermore, in the password input screen 800, the region 806 representing a writing location of a password of the AP identified as a connection target for the communication apparatus 151 is a region which is displayed in preparation for a case where the predetermined application has been unable to correctly recognize a password of an AP to which the user wants to cause the communication apparatus 151 to connect in step S1010. Furthermore, the region 806 representing a writing location of a password of the AP identified as a connection target for the communication apparatus 151 is a region representing a location at which to confirm the above-mentioned password of the AP while the predetermined application has been kept in foreground. For example, as the writing location of the password of the AP, the main body of a wireless router or a manual of the wireless router is indicated. This is because, as mentioned above, if, after a connection between the terminal device 101 and the communication apparatus 151 has been established based on information acquired by execution of the ASK, the predetermined application is caused to transition to background, the above-mentioned connection may be severed. Therefore, in one embodiment, when prompting the user to confirm the above-mentioned password of the AP in the password input screen which is displayed after the above-mentioned connection has been established, the predetermined application is required to be in the state of being kept in foreground without being caused to transition to background. Thus, in the screen 800, as a location for confirming the above-mentioned password of the AP, a location for confirming the above-mentioned password of the AP while the predetermined application is kept in foreground is indicated.

In step S1017, the predetermined application determines whether a user operation on the cancel button 805 has been received. If the result of determination is YES (YES in step S1017), the predetermined application ends the processing and then displays a home screen of the predetermined application. Moreover, if the result of determination is NO (NO in step S1017), the predetermined application advances the processing to step S1018.

In step S1018, the predetermined application determines whether the change button 802 has been operated. If the result of determination is YES (YES in step S1018), the predetermined application returns the processing to step S1014, thus waiting for receiving any operation in the screen for displaying the AP list, and, if the result of determination is NO (NO in step S1018), the predetermined application advances the processing to step S1019.

In step S1019, the predetermined application determines whether a user operation on the “connect” button 804 has been received in a state in which a password has been input to the password inputting box 803. If the result of determination is YES (YES in step S1019), the predetermined application advances the processing to step S1020, and, if the result of determination is NO (NO in step S1019), the predetermined application returns the processing to step S1017, thus waiting for receiving ay operation in the password input screen 800 from the user.

In step S1020, the predetermined application transmits, to the communication apparatus 151, information for connecting to the AP identified as a connection target for the communication apparatus 151. The information to be transmitted here includes, specifically, the password input to the password inputting box 803 and the SSID of the AP identified as a connection target for the communication apparatus 151. Furthermore, the AP identified as a connection target is an AP selected from the list of APs displayed in step S1014. Furthermore, after the information for connecting to the AP identified as a connection target for the communication apparatus 151 has been transmitted to the communication apparatus 151, the communication apparatus 151 ends the connection setting mode and, with use of the received information, connects to the AP identified as a connection target for the communication apparatus 151. After the connection setting mode has ended, as with step S312, the terminal device 101 reconnects to a predetermined AP with use of the function of the OS. Furthermore, in the first embodiment, the predetermined AP in the second connection setting process is an AP to which the terminal device 101 is connecting by Wi-Fi at the start timing of the flowchart of FIG. 10. After the terminal device 101 has reconnected to the predetermined AP, the predetermined application advances the processing to step S1021.

In step S1021, as with step S313, the predetermined application searches for a communication apparatus 151 via a Wi-Fi network to which the terminal device 101 is connecting. In a case where the communication apparatus 151 has been found by the searching, the terminal device 101 acquires, from the communication apparatus 151, information concerning the communication apparatus 151 via a Wi-Fi network to which the terminal device 101 is connecting, and then registers the communication apparatus 151 with the predetermined application. Furthermore, at this time, the predetermined application can automatically set the new registered communication apparatus 151 as a currently selected communication apparatus 151. After that, the predetermined application ends the processing, and then displays a home screen of the predetermined application.

Furthermore, in the first embodiment, the predetermined application can display a confirmation screen for prompting the user to confirm whether to set the predetermined AP as a connection target for the communication apparatus 151 by referring to a list of APs found by searching which the predetermined AP and the communication apparatus 151 have performed.

### Second Embodiment

A second embodiment is configured to perform the second connection setting process by a method different from that in the first embodiment. Specifically, in the first embodiment, a configuration in which, based on the model name of communication equipment having been identified, information corresponding to the model is identified as information which is used for searching and the searching for communication equipment is performed with use of the identified information is employed. In other words, a configuration in which, unless the model name is identified, the searching for a communication apparatus is not performed by the OS is employed. On the other hand, in the second embodiment, in order to ensure that, even in a case where the model name is not identified, the searching for a communication apparatus is performed by the OS, in the model name input screen, a “model name being unknown” button (a button 1703 included in the model name input screen 1700) is provided. Furthermore, the “model name being unknown” button is a button which is operated in a case where the user does not recognize the model name and no model name is input to the model name input screen. In the second embodiment, a configuration in which, based on the “model name being unknown” button having been operated by the user, information corresponding to the vendor name is identified as information which is used for searching and the searching for a communication apparatus is performed with use of the identified information is employed. Thus, the second embodiment is configured to, unlike the first embodiment, perform control in such a manner that, even in a case where the model name is not identified, the searching for communication equipment is performed by the OS.

In the second embodiment, as with the first embodiment, the SSID of the connection setting AP is assumed to include a model-by-model common character string, a character string which is in common between apparatuses of a plurality of models, and an individual character string.

However, unlike the first embodiment, the character string which is in common between apparatuses of a plurality of models is assumed to be a character string including a vendor name. Furthermore, the character string which is in common between apparatuses of a plurality of models is not limited to this configuration, but can be, for example, not a character string including a vendor name but a character string allocated for each vendor.

Furthermore, in one embodiment, the SSID of the connection setting AP only needs to include a model-by-model common character string and a character string which is in common between apparatuses of a plurality of models. Therefore, a configuration in which the SSID of the connection setting AP includes a model-by-model common character string and a character string which is in common between apparatuses of a plurality of models but does not include an individual character string can be employed.

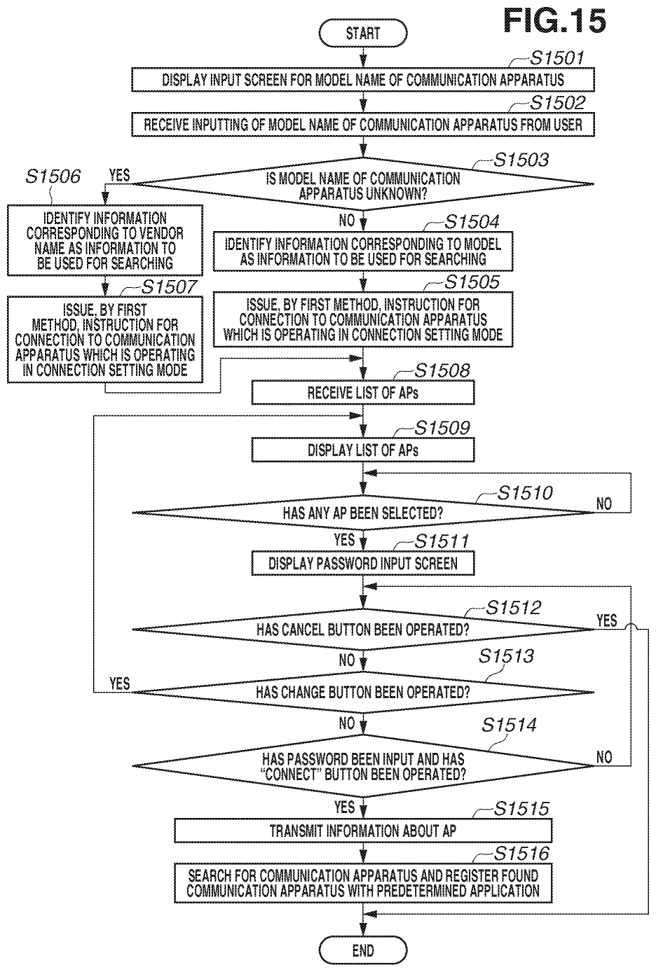

FIG. 15 is a flowchart illustrating an example of the first connection setting process in the second embodiment. Furthermore, each processing operation in the flowchart of FIG. 15 is implemented by, for example, the CPU 103 loading the predetermined application stored in a memory such as the ROM 104 onto the RAM 105 and executing the predetermined application.

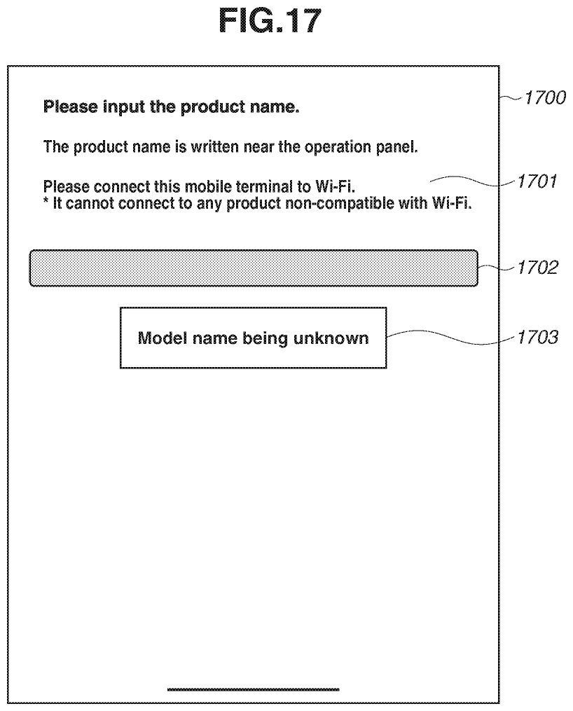

In step S1501, the predetermined application displays an input screen for the model name of a communication apparatus. An example of the model name input screen is illustrated in FIG. 17. The model name input screen 1700 includes a region 1701 representing a method for confirming the model name, a model name inputting box 1702, and a “model name being unknown” button 1703. The region 1701 representing a method for confirming the model name and the model name inputting box 1702 are similar to the region 501 indicating the display position of the model name and the model name inputting box 502 and are, therefore, omitted from description here. The “model name being unknown” button 1703 is a button which is operated in a case where the user does not recognize the model name of a communication apparatus targeted for searching and no model name is unable to be input to the model name inputting box 1702.

In step S1502, the predetermined application receives inputting of a model name of the communication apparatus from the user. Specifically, the predetermined application receives inputting of at least a part of a character string of the model name of a communication apparatus targeted for searching to the model name inputting box 1702. The details of the processing operation in step S1502 are similar to those in step S302.

In step S1503, the predetermined application determines whether the model name of the communication apparatus is unknown.

Specifically, the predetermined application determines whether the “model name being unknown” button 1703 has been operated. If the result of determination is YES (YES in step S1503), the predetermined application advances the processing to step S1506. Moreover, if the result of determination is NO (NO in step S1503), the predetermined application advances the processing to step S1504. Furthermore, the case where, in the processing operation, the result of determination is NO is a case where the “model name being unknown” button 1703 has not been operated and the model name of a communication apparatus targeted for searching has been identified. The case where the model name of a communication apparatus targeted for searching has been identified has been described above with regard to step S302 and is, therefore, omitted from description here.

In step S1504, as with step S303, the predetermined application identifies information corresponding to the model as information to be used for searching for a communication apparatus which is performed by the OS. In the second embodiment, as with the first embodiment, the predetermined application preliminarily retains a plurality of character strings allocated for each model name. Therefore, in the processing operation, the predetermined application identifies, as information corresponding to the model, a character string corresponding to the model name identified in step S1502 from among the above-mentioned plurality of character strings. The character string to be identified here is a character string of at least a part of the character string constituting the SSID of a connection setting AP which an apparatus with the model name identified in step S1502 enables at the time of the connection setting mode, and is a model-by-model common character string. Moreover, in the processing operation, the information corresponding to the model includes a character string indicating a model name identified based on the input received from the user in step S1502. Furthermore, in the second embodiment, the predetermined application can identify, as information corresponding to the model, only a character string indicating the model name thereof or can identify, as information corresponding to the model, a character string indicating the model name thereof and a character string including a vendor name which is a character string which is in common between apparatuses of a plurality of models. Furthermore, the character string which is in common between apparatuses of a plurality of models is a character string which is preliminarily retained by the predetermined application.

In step S1505, as with step S304, the predetermined application performs, by a first method, processing for establishing a connection between the communication apparatus 151 which is operating in the connection setting mode and the terminal device 101. The details of the first method have been described above with regard to step S304 and are, therefore, omitted from description here.

Furthermore, in the processing operation, the character string of at least a part of the SSID of the communication apparatus 151 which is operating in the connection setting mode is a character string included in the information corresponding to the mode identified in step S1504. The information corresponding to the model identified in step S1504 is, specifically, equivalent to a character string corresponding to the model name identified based on an input received from the user in step S1502. Furthermore, a configuration in which, in the SSID of the communication apparatus 151 which is operating in the connection setting mode, a character string which is in common between apparatuses of a plurality of models and a model-by-model common character string are included can be employed. In that configuration, the character string identified in step S1504 is equivalent to the SSID of the communication apparatus 151 which is operating in the connection setting mode. In a case where, in step S1504, the above-mentioned character string representing the model name and a character string including a vendor name which is in common between apparatuses of a plurality of models have been identified, while setting, as an argument, not a part of but the entire text of the SSID of the communication apparatus 151 which is operating in the connection setting mode, the predetermined application can invoke the first API for establishing a connection of the terminal device 101.

In response to an instruction from the predetermined application, the OS searches for an apparatus having an SSID including the character string concerned, and then establishes a connection between the found communication apparatus 151 and the terminal device 101. Furthermore, the communication apparatus 151 to which the terminal device 101 connects by the processing operation is equivalent to a model corresponding to the model name identified based on the input received from the user in step S1502. Moreover, the communication apparatus 151 to which the terminal device 101 connects by the processing operation is assumed to be a communication apparatus which has been found first by searching performed by the processing operation in step S1505.

In step S1506, which is performed in a case where the result of determination in step S1503 is YES, the predetermined application identifies information corresponding to a vendor name as information to be used for searching for the communication apparatus 151 which is performed by the OS. In the processing operation, the information corresponding to a vendor name includes, specifically, a character string including a vendor name which is preliminarily retained by the predetermined application. The character string to be identified here is a character string of at least a part of the character string constituting the SSID of the connection setting AP which a communication apparatus provided by a predetermined vendor enables at the time of the connection setting mode, and is a character string which is in common between apparatuses of a plurality of models. Furthermore, the character string to be identified in the processing operation is assumed to include no model-by-model common character string.

In step S1507, as with step S304, the predetermined application performs, by a first method, processing for establishing a connection between the communication apparatus 151 which is operating in the connection setting mode and the terminal device 101. The details of the first method have been described above with regard to step S304 and are, therefore, omitted from description here. As mentioned above with regard to step S304, in the processing operation, while setting, as an argument, a character string of at least a part of the SSID of the communication apparatus 151 which is operating in the connection setting mode, the predetermined application invokes the first API for establishing a connection of the terminal device 101. Furthermore, the character string of at least a part of the SSID of the communication apparatus 151 which is operating in the connection setting mode is equivalent to the information corresponding to a vendor name identified in step S1506. The character string identified in step S1506 is, specifically, equivalent to a character string including a vendor name which is preliminarily retained by the predetermined application.

In response to an instruction from the predetermined application, the OS searches for an apparatus having an SSID including the character string concerned, and then establishes a connection between the found communication apparatus 151 and the terminal device 101. Furthermore, the communication apparatus 151 to which the terminal device 101 connects by the processing operation is assumed to be a communication apparatus which has been found first by searching performed by the processing operation in step S1507.

Processing operations in step S1508 to step S1516 are similar to those in step S305 to step S313 and are, therefore, omitted from description here.

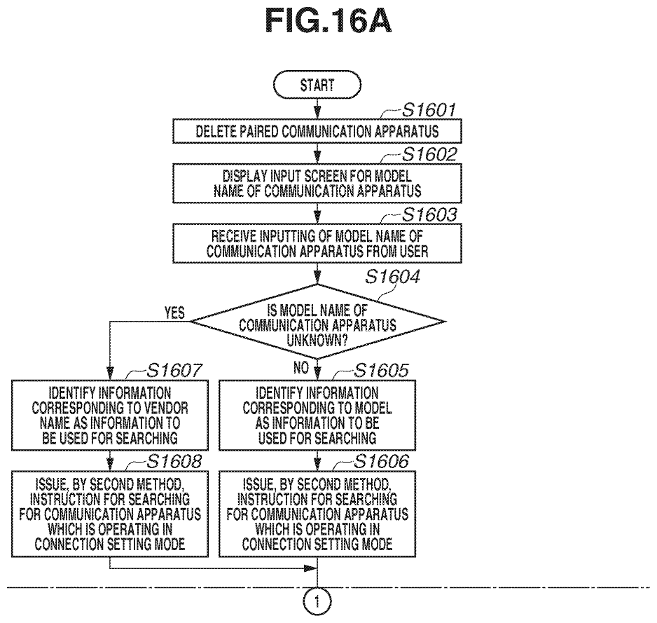

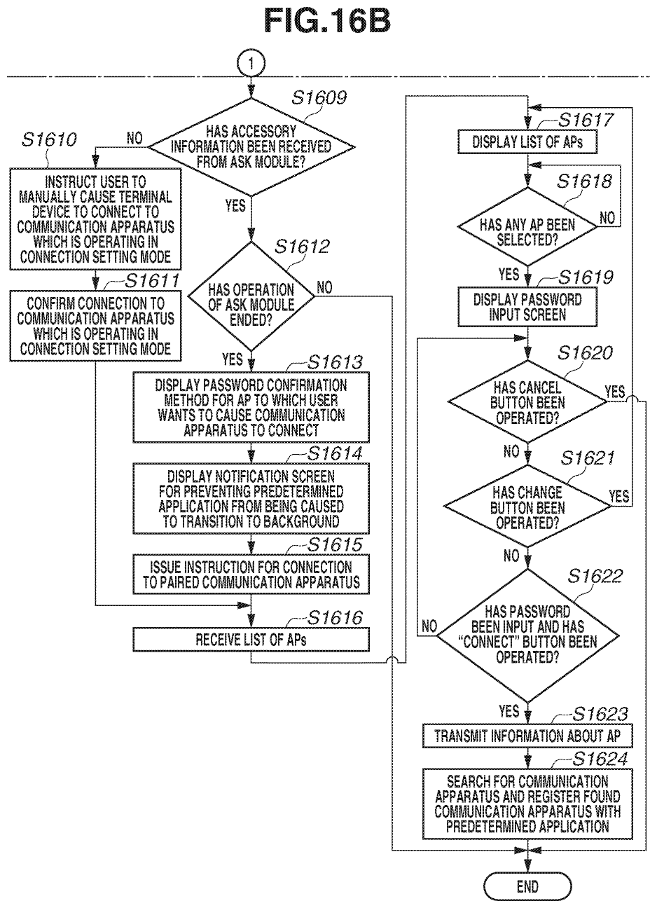

FIGS. 16A and 16B are flowcharts illustrating an example of the second connection setting process in the second embodiment. Furthermore, each processing operation in the flowcharts of FIGS. 16A and 16B is implemented by, for example, the CPU 103 loading the predetermined application stored in a memory such as the ROM 104 onto the RAM 105 and executing the predetermined application.

A processing operation in step S1601 is similar to that in step S1001 and is, therefore, omitted from description here. Processing operations in step S1602 to step S1604 are similar to those in step S1501 to step S1503 and are, therefore, omitted from description here.

In step S1605, the predetermined application identifies information corresponding to the model as information to be used for searching for a communication apparatus which is performed by the ASK module. In the processing operation, the information corresponding to the model includes a character string representing a model name identified based on an input received from the user in step S1603 and image data corresponding to the model concerned. As mentioned above, in the second embodiment, the predetermined application preliminarily retains a plurality of character strings allocated for each model name. Therefore, in the processing operation, the predetermined application identifies, as information corresponding to the model, a character string corresponding to the model name identified in step S1603. The character string to be identified here is a character string of at least a part of a character string constituting the SSID of a connection setting AP which an apparatus with the model name identified in step S1603 enables at the time of the connection setting mode, and is a model-by-model common character string. Additionally, in the second embodiment, the predetermined application preliminarily retains a plurality of pieces of image data allocated for each model name. Therefore, in the processing operation, the predetermined application identifies, as information corresponding to the model, image data corresponding to the model name identified in step S1603 from among the above-mentioned plurality of pieces of image data.

In step S1606, as with step S1005, the predetermined application issues, by a second method, an instruction for searching for a communication apparatus which is operating in the connection setting mode. The details of the second method have been described above with regard to step S1005 and are, therefore, omitted from description here. In the processing operation, the predetermined application notifies the ASK module of the character string identified in step S1605 and the image data identified in step S1605. Furthermore, the communication apparatus 151 which is operating in the connection setting mode is equivalent to a model corresponding to the model name identified based on the input received from the user in step S1603.

In step S1607, which is performed in a case where the result of determination in step S1604 is YES, the predetermined application identifies information corresponding to a vendor name as information to be used for searching for the communication apparatus 151 which is performed by the ASK module. In the processing operation, the information corresponding to a vendor name includes a character string which is in common between apparatuses of a plurality of models and image data about a generalized communication apparatus serving as image data which is in common between apparatuses of a plurality of models. The image data about a generalized communication apparatus is image data which is preliminarily retained by the predetermined application, and is assumed to be image data different from a plurality of pieces of image data allocated for each model name. The character string which is in common between apparatuses of a plurality of models includes, specifically, a character string including a vendor name which is preliminarily retained by the predetermined application. The character string to be identified here is a character string of at least a part of the character string constituting the SSID of the connection setting AP which a communication apparatus provided by a predetermined vendor enables at the time of the connection setting mode, and is a character string which is in common between apparatuses of a plurality of models. Furthermore, the character string to be identified in the processing operation is assumed to include no model-by-model common character string.

In step S1608, as with step S1005, the predetermined application issues, by a second method, an instruction for searching for a communication apparatus which is operating in the connection setting mode. The details of the second method have been described above with regard to step S1005 and are, therefore, omitted from description here. In the processing operation, the predetermined application notifies the ASK module of the character string identified in step S1607 and the image data identified in step S1607. Furthermore, the communication apparatus 151 which is operating in the connection setting mode is equivalent to a model corresponding to the model name identified based on the input received from the user in step S1603. Furthermore, the details of the SSID of the communication apparatus 151 which is operating in the connection setting mode are similar to those described with regard to step S1505 and are, therefore, omitted from description here.

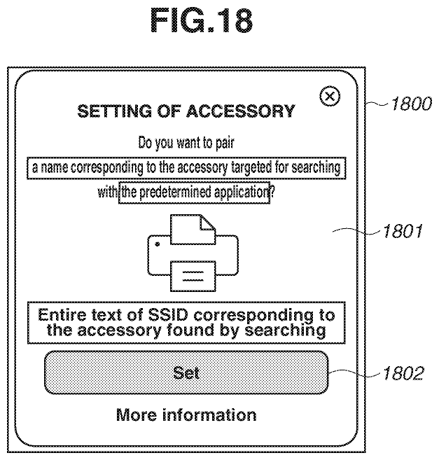

In step S1609, the predetermined application determines whether accessory information has been received from the ASK module. Furthermore, the accessory information includes the entire text of the SSID corresponding to the communication apparatus found by searching. If the result of determination is YES, a screen representing a search result is displayed by the ASK module. Examples of the screen indicating a search result are illustrated in FIGS. 11A and 11B and FIG. 18. The screen 1110 is a screen representing a search result which is displayed based on the model name of the communication apparatus being identified in step S1603 and the result of determination in step S1604 being NO. On the other hand, the screen 1800 is a screen representing a search result which is displayed based on the model name of the communication apparatus not being identified in step S1603 and the result of determination in step S1604 being YES. The screen 1800 includes a region 1801 in which a name corresponding to an accessory targeted for searching, an image of a generalized communication apparatus, and the entire text of an SSID corresponding to an accessory found by searching are displayed and a button 1802 which is operable to determine any one of apparatuses found by the ASK module as an apparatus targeted for pairing. Furthermore, the entire text of the SSID corresponding to the accessory found by searching is included in the accessory information which the ASK module has acquired based on an accessory having been found by searching. Furthermore, the image of a generalized communication apparatus is image data which is preliminarily retained by the predetermined application, and is an image which is represented by image data different from a plurality of pieces of image data allocated for each model name. In response to the button 1802 being operated, the ASK module displays a screen indicating that the above-mentioned accessory has become available. An example of the screen is illustrated in FIG. 12. The screen 1200 includes a “continue with application” button 1201. In response to the button 1201 being operated, the ASK module notifies the predetermined application of ending an operation of the ASK module, thus ending an operation of the ASK module. If the result of determination is YES (YES in step S1609), the predetermined application advances the processing to step S1612, and, if the result of determination is NO (NO in step S1609), the predetermined application advances the processing to step S1610.

Processing operations in step S1610 and step S1611 are similar to those in step S1007 and step S1008. Furthermore, after the processing operation in step S1611 is performed, the predetermined application advances the processing to step S1616, without performing processing for displaying a method of password confirmation of an AP to which the user wants to perform connection, processing for displaying a notification screen for preventing or reducing the predetermined application from transitioning to background, and processing for issuing an instruction for connecting to the paired communication apparatus, such as those in step S1613 to step S1615.

Processing operations in step S1612 to step S1624 are similar to those in step S1009 to step S1021 and are, therefore, omitted from description here.

Furthermore, in the second embodiment, the predetermined application can display a confirmation screen for prompting the user to confirm whether to set the predetermined AP as a connection target for the communication apparatus 151 by referring to a list of APs found by searching which the predetermined AP and the communication apparatus 151 have performed. Furthermore, in the second embodiment, the predetermined AP in the second connection setting process is an AP to which the terminal device 101 is connecting by Wi-Fi at the start timing of the flowcharts of FIGS. 16A and 16B.

With such a configuration employed, in connection setting process using information acquired by the ASK module, the predetermined application is able to improve usability in establishing a connection between the communication apparatus 151 and the terminal device 101.

### Other Embodiments

While, in the above-described embodiments, a configuration in which a connection between the communication apparatus 151 which is operating in the connection setting mode and the terminal device 101 is Wi-Fi has been described, the above-described embodiments are not limited to this configuration. The connection between the communication apparatus 151 which is operating in the connection setting mode and the terminal device 101 can be established by a communication method other than Wi-Fi, such as Bluetooth Classic or Bluetooth Low Energy. Furthermore, the connection which is established in the first connection setting process can be established by a communication method other than Wi-Fi and the connection which is established in the second connection setting process can be established by a communication method other than Wi-Fi. Thus, the acquisition of accessory information from the communication apparatus 151 by the ASK module can be performed by a communication method other than Wi-Fi and the connection which is established based on the acquired accessory information can be established by a communication method other than Wi-Fi. This is because the ASK module has a function capable of, as mentioned above, managing, as an accessory, an apparatus capable of performing communication using Bluetooth. In that case, while establishing a connection between the communication apparatus 151 which is operating in the connection setting mode and the terminal device 101, the terminal device 101 can also keep a Wi-Fi connection between the terminal device 101 and the predetermined AP.

Thus, there is a configuration in which a connection between the communication apparatus 151 which is operating in the connection setting mode and the terminal device 101 is a connection using Wi-Fi. In that configuration employed, the predetermined AP is an AP to which the terminal device 101 has been connecting when processing serving as a trigger for starting of the flowchart of FIG. 3, FIG. 9, FIG. 10, FIG. 15, or FIGS. 16A and 16B has been performed but to which the terminal device 101 is not connecting when information about the predetermined AP is transmitted to the communication apparatus 151. On the other hand, there is a configuration in which a connection between the communication apparatus 151 which is operating in the connection setting mode and the terminal device 101 is a connection using a communication method other than Wi-Fi. In that configuration employed, the predetermined AP is an AP to which the terminal device 101 is connecting both when processing serving as a trigger for starting of the flowchart of FIG. 3, FIG. 9, FIG. 10, FIG. 15, or FIGS. 16A and 16B has been performed and when information about the predetermined AP is transmitted to the communication apparatus 151. Therefore, it can be said that the predetermined AP is an AP to which the terminal device 101 has been connecting at least when processing serving as a trigger for starting of the flowchart of FIG. 3, FIG. 9, FIG. 10, FIG. 15, or FIG. 16A and has been performed.

In the second connection setting process, the above-described embodiments are not limited to, after a connection between the terminal device 101 and the communication apparatus 151 has been established by the ASK module, performing connection setting process. Specifically, the above-described embodiments can be configured to, after a connection between the terminal device 101 and the communication apparatus 151 has been established by AccessorySetupKit, transmit a print job.

In the first connection processing, the sequential order of determinations in step S309 to step S311 or determinations in step S1017 to step S1019 are not particularly limited, and determinations in step S309 to step S311 or determinations in step S1017 to step S1019 can be performed in any sequential order.

While, in the first connection processing, a configuration in which the list of APs which is displayed in step S306 or step S1509 is a list of APs found by searching which the communication apparatus 151 has performed has been described, the first connection processing is not limited to this configuration. The list of APs which is displayed in step S306 or step S1509 can be a list of APs found by searching which the terminal device 101 has performed. In that configuration, the processing operation in step S305 or step S1508 can be omitted.

In the second connection setting process, a configuration in which, in a screen for password confirmation in the first embodiment and the second embodiment, as a region for password confirmation, a region in which a sentence for explaining a specific password confirmation method is written is displayed has been described. However, the second connection setting process is not limited to this configuration. As a region for password confirmation, a button for password confirmation can be displayed in the above-mentioned screen for password confirmation and, when the button for password confirmation has been operated, a new screen for password confirmation can be displayed. Thus, in the second connection processing, the button for password confirmation can be displayed in the screen for password confirmation.

In the second connection processing, the sequential order of determinations in step S1512 to step S1514 or determinations in step S1620 to step S1622 are not particularly limited, and determinations in step S1512 to step S1514 or determinations in step S1620 to step S1622 can be performed in any sequential order.

While, in the second connection processing, a configuration in which the list of APs which is displayed in step S1014 or step S1617 is a list of APs found by searching which the communication apparatus 151 has performed has been described, the second connection processing is not limited to this configuration. The list of APs which is displayed in step S1014 or step S1617 can be a list of APs found by searching which the terminal device 101 has performed. In that configuration, the processing operation in step S1013 or step S1616 can be omitted.

In the above-described embodiments, the predetermined application can transmit setting information to the communication apparatus without displaying a screen for AP password confirmation, an AP password input screen, and a notification screen for preventing or reducing the predetermined application from transitioning to background.

Moreover, while, in the first embodiment, a configuration in which the processing operations in step S908 and step S909 are performed to control whether to perform the first connection setting process or perform the second connection setting process, based on the above-mentioned predetermined condition is employed, the first embodiment is not limited to this configuration. For example, in one embodiment, a configuration which performs only the second connection setting process without switching between execution of the first connection setting process and execution of the second connection setting process.

According to an aspect of the disclosure, it is possible to improve the usability of an application program for performing processing for transmitting, to a communication apparatus, information required for connecting to an access point.

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the disclosure has been described with reference to embodiments, it is to be understood that the disclosure is not limited to the disclosed embodiments. The scope of the following claims is to be accorded the broadest interpretation so as to encompass all such modifications and equivalent structures and functions.

This application claims the benefit of Japanese Patent Application No. 2025-059906 filed Mar. 31, 2025, which is hereby incorporated by reference herein in its entirety.

What is claimed is:

1. A non-transitory computer-readable storage medium storing a program for communicating with a communication apparatus, the program causing a computer of an information processing apparatus equipped with an operating system (OS) including an AccessorySetupKit (ASK) module to perform a method comprising:
receiving, from a user, an input concerning a model of the communication apparatus targeted for searching;
notifying the ASK module of image data representing a model corresponding to the received input and a character string corresponding to the model corresponding to the received input; and
transmitting connection information for connecting to an external access point to the communication apparatus found by searching performed by the ASK module in response to being notified of the image data and the character string,
wherein, in a case where an apparatus having identification information including the character string is searched for by the ASK module and the communication apparatus having identification information including the character string has been found by the ASK module, an image represented by the image data is displayed by the ASK module.

2. The non-transitory computer-readable storage medium according to claim 1, further comprising controlling whether to perform a first connection setting process for transmitting the connection information to the communication apparatus via a connection which is established without use of information acquired by the ASK module or to perform a second connection setting process for transmitting the connection information to the communication apparatus via a connection which is established with use of information acquired by the ASK module, based on a predetermined condition.

3. The non-transitory computer-readable storage medium according to claim 2,
wherein the predetermined condition is that the OS included in the information processing apparatus is an OS with a version higher than or equal to a specific version, and
wherein the second connection setting process is performed based on the predetermined condition being satisfied and the first connection setting process is performed based on the predetermined condition not being satisfied.

4. The non-transitory computer-readable storage medium according to claim 3,
wherein the OS included in the information processing apparatus iOS® or iPadOS®, and
wherein the specific version is iOS 18 or iPadOS 18.

5. The non-transitory computer-readable storage medium according to claim 2,
wherein the predetermination condition is that a predetermined access point which is an access point to which the information processing apparatus has been connecting when a predetermined operation has been received on a screen which at least the predetermined application program displays is compatible with a frequency band of 2.4 gigahertz (GHz),
wherein the second connection setting process is performed based on the predetermined condition being satisfied and the first connection setting process is performed based on the predetermined condition not being satisfied, and
wherein the connection information is transmitted from the information processing apparatus to the communication apparatus based on the predetermined operation having been received.

6. The non-transitory computer-readable storage medium according to claim 2,
wherein the connection which is established with use of information acquired by the ASK module is a connection which is unable to be controlled by processing which the predetermined application program performs in such a manner that the connection which is established with use of information acquired by the ASK module is not severed even if the predetermined application program has been caused to transition to background, and
wherein the connection which is established without use of information acquired by the ASK module is a connection which is able to be controlled by processing which the predetermined application program performs in such a manner that the connection which is established without use of information acquired by the ASK module is not severed even if the predetermined application program has been caused to transition to background.

7. The non-transitory computer-readable storage medium according to claim 2, wherein an application programming interface (API) which is invoked by the program to establish the connection which is established without use of information acquired by the ASK module and an API which is invoked by the program to establish the connection which is established with use of information acquired by the ASK module are different from each other.

8. The non-transitory computer-readable storage medium according to claim 1, wherein the program instructs the OS to search for the communication apparatus while setting, as an argument, a character string of at least a part of a service set identifier (SSID) of the communication apparatus which is operating in a connection setting mode, the character string corresponding to a model corresponding to the received input.

9. The non-transitory computer-readable storage medium according to claim 1, further comprising, based on the communication apparatus having been found by the ASK module, acquiring, from the ASK module, accessory information corresponding to the communication apparatus found by the ASK module, and
wherein, in a case where the accessory information has been acquired from the ASK module, the image is displayed by the ASK module.

10. The non-transitory computer-readable storage medium according to claim 9, further comprising, in a case where, based on the communication apparatus having not been found by the ASK module, the accessory information has not been acquired from the ASK module, performing specific processing for manually establishing a connection to the communication apparatus,
wherein the specific processing is processing for displaying a screen for presenting, to the user, a method for establishing a connection to the communication apparatus on a screen which another application program different from the predetermined application program displays.

11. The non-transitory computer-readable storage medium according to claim 1, further comprising, based on the input concerning the model of the communication apparatus having not been received, notifying the ASK module of an image which is in common between a predetermined model which a predetermined vendor provides and another model which the predetermined vendor provides and a character string which is in common therebetween.

12. The non-transitory computer-readable storage medium according to claim 1, further comprising
displaying a notification screen for preventing the program from transitioning to background in a predetermined period, and
wherein the notification screen is displayed before a connection which is established with use of information acquired by the ASK module is established.

13. The non-transitory computer-readable storage medium according to claim 1, further comprising:
displaying a predetermined screen including a first region for causing the user to confirm a password for connecting to the access point, at predetermined timing which is timing after the program has been activated and is timing before a connection which is established with use of information acquired by the ASK module is established; and
displaying a password input screen including a second region for receiving inputting of the password from the user, after the connection has been established.

14. The non-transitory computer-readable storage medium according to claim 13
wherein the password input screen includes a third region for causing the user to confirm the password, and
wherein the third region includes a region for representing a confirmation method for causing the user to confirm the password in a state in which the program is kept in foreground.

15. The non-transitory computer-readable storage medium according to claim 1, further comprising
searching for the communication apparatus on a network to which the information processing apparatus has been connecting at least at timing when a predetermined operation has been received on a screen which the program displays;
notifying, in a case where the communication apparatus has been found by searching, the ASK module of the image and the character string and transmitting the connection information to the communication apparatus are not performed; and
notifying, in a case where the communication apparatus has not been found by searching, the ASK module of the image and the character string and transmitting the connection information to the communication apparatus are performed.

16. The non-transitory computer-readable storage medium according to claim 1, further comprising:
searching for the communication apparatus compatible with a connection setting function included as standard in the OS;
in a case where the communication apparatus compatible with the connection setting function included as standard in the OS has been found by searching, performing connection setting included as standard in the OS without performing processing for notifying the ASK module of the image and the character string and processing for transmitting the connection information to the communication apparatus;
in a case where the communication apparatus compatible with the connection setting function included as standard in the OS has not been found by searching, performing processing for notifying the ASK module of the image and the character string and processing for transmitting the connection information to the communication apparatus; and
in a case where the communication apparatus compatible with the connection setting function included as standard in the OS has been found by searching, controlling whether to execute the connection setting function, based on a specific operation.

17. The non-transitory computer-readable storage medium according to claim 1, further comprising transmitting at least one of a print job for causing the communication apparatus to perform printing and a scan job for causing the communication apparatus to perform scanning.

18. The non-transitory computer-readable storage medium according to claim 1, wherein a connection between the information processing apparatus and the communication apparatus which is used for transmission of the connection information is a connection using a communication method that is based on the standard of IEEE 802.11 series.

19. A method for an information processing apparatus having a program for communicating with a communication apparatus and equipped with an operating system (OS) including an AccessorySetupKit (ASK) module, the method comprising:
receiving, from a user, an input concerning a model of the communication apparatus targeted for searching;
notifying the ASK module of image data representing a model corresponding to the received input and a character string corresponding to the model corresponding to the received input; and
transmitting connection information for connecting to an external access point to the communication apparatus found by searching performed by the ASK module in response to being notified of the image data and the character string,
wherein, in a case where an apparatus having identification information including the character string is searched for by the ASK module and the communication apparatus having identification information including the character string has been found by the ASK module, an image represented by the image data is displayed by the ASK module.

20. An information processing apparatus having a program for communicating with a communication apparatus and equipped with an operating system (OS) including an AccessorySetupKit (ASK) module, the information processing apparatus comprising:
at least one processor; and
at least one memory coupled to the at least one processor, the at least one memory having instructions that, when executed by the at least one processor, perform operations as:
a reception unit configured to receive, from a user, an input concerning a model of the communication apparatus targeted for searching;
a notification unit configured to notify the ASK module of image data representing a model corresponding to the received input and a character string corresponding to the model corresponding to the received input; and
a transmission unit configured to transmit connection information for connecting to an external access point to the communication apparatus found by searching performed by the ASK module in response to being notified of the image data and the character string,
wherein, in a case where an apparatus having identification information including the character string is searched for by the ASK module and the communication apparatus having identification information including the character string has been found by the ASK module, an image represented by the image data is displayed by the ASK module.
